(19) United States
(12) Patent Application Publication
(10) Pub. No.: US 2022/0394671 A1
(43) Pub. Date: Dec. 8, 2022

(54) Systems and Methods for UE-specific Notifications with Beamforming

(71) Applicant: HUAWEI TECHNOLOGIES CO., LTD., Shenzhen (CN)

(72) Inventors: LIQING ZHANG, Ottawa (CA); JIANGLEI MA, Ottawa (CA); YONGXIA LYU, Ottawa (CA)

(21) Appl. No.: 17/891,198

(22) Filed: Aug. 19, 2022

Related U.S. Application Data
(63) Continuation of application No. PCT/CN2020/114131, filed on Sep. 9, 2020.

(51) Int. Cl. H04W 68/02; H04B 7/06

(52) U.S. Cl. CPC H04W 68/02; H04B 7/0617; H04W 52/0229

(57) ABSTRACT

When a UE is in a power saving state, and the network has downlink data to send to the UE, a paging message may be transmitted in the downlink. Paging may have high overhead when beamforming is implemented. In some embodiments, a UE-specific notification is instead transmitted in a downlink beam pointed in the direction of the UE. The UE-specific notification may be a paging message specific to the UE that indicates that there is downlink data for transmission to that UE. However, more generally the UE-specific notification may be any type of downlink notification for a UE. The notification may include downlink beam information.

### CROSS-REFERENCE TO RELATED APPLICATION

The present application is a continuation of PCT/CN2020/114131, titled “Systems and Methods for UE-specific Notifications with Beamforming”, filed on Sep. 9, 2020, and incorporated herein by reference.

### FIELD

The present application relates to wireless communication, and more specifically to downlink notifications (e.g. paging messages) in a wireless communication system.

### BACKGROUND

In some wireless communication systems, user equipments (UEs) wirelessly communicate with one or more base stations. A base station may be referred to as a transmission-and-reception point or transmit-and-receive point (TRP). A base station may be a network access node in a Terrestrial Network (TN), such as a cellular network, or a Non-Terrestrial Network (NTN) such as a satellite network. A wireless communication from a UE to a base station is referred to as an uplink communication. A wireless communication from a base station to a UE is referred to as a downlink communication. Resources are required to perform uplink and downlink communications. For example, a base station may wirelessly transmit data to a UE in a downlink communication at a particular frequency for a particular duration of time. The frequency and time duration are examples of resources.

Beamforming may be implemented by a base station and/or by a UE. For example, a downlink beamforming method may be implemented by the base station in which the base station directs a downlink transmission in a particular direction, e.g. by performing signal processing that causes the transmitted signals from a plurality of antenna elements to experience constructive interference and form a signal beam towards the particular direction. A beam transmitted by a base station using beamforming typically has a narrow beam width and does not cover the whole coverage area of the base station. Therefore, some information, such as information used by UEs to synchronize to the network, may be transmitted over multiple beams according to a beam sweeping pattern. In some beam sweeping methods, a plurality of beams are transmitted, each at a respective different direction and each at a respective different time, in order to cover the coverage area of the base station. As an example, asynchronization signal block (SSB) may be transmitted in each beam. A UE may synchronize and obtain system information using the SSB in the beam that is strongest for that UE.

A UE may possibly operate in different power states. For example, a UE may operate in a power saving state. When operating in the power saving state, the UE might not fully occupy the system resources available for downlink and/or uplink transmission, e.g. the UE might not utilize all transmission parameters and time-frequency resources available for downlink and/or uplink transmission. The UE might not constantly (or as often) monitor for network instructions on the downlink, e.g. the UE might not monitor the physical downlink control channel (PDCCH) as often. This is especially important for reduced capacity (RedCap) commercial devices or UEs such as wearable devices, low cost industry wireless devices, and internet of thing (IoT) device. Monitoring the PDCCH or downlink control information may be performed in a wake-up period of one DRX cycle (or DRX on window). When not operating in the power saving state, e.g. when the UE operates in a normal or higher power-consumption state, the UE may fully occupy the system resources (e.g. the transmission parameters and/or time-frequency resources) that are available for uplink and/or downlink transmission, and/or the UE may constantly (or more often) monitor for network instructions on the downlink. For example, the UE may monitor the PDCCH regularly or more often than the power saving state.

When a UE is in a power saving state, e.g. the UE is in an Inactive or Idle state, and the network has downlink data to send to the UE, a paging message may be transmitted in the downlink. When beamforming is implemented, the same paging message may need to be transmitted in multiple beams.

### SUMMARY

Paging in the power saving state in current networks may have high overhead when beamforming is implemented. For example, assume the network wants to send a paging message indicating the presence of downlink data for a particular UE. The particular UE is not in a connected state, and the location of the particular UE is only known generally, e.g. within a given radio access network (RAN), called a RAN tracking area. For example, the RAN tracking area is covered by 7 cells, where each cell is served by a different base station, and each base station implements a beam sweeping pattern involving 32 different beams. The paging message is therefore sent in all 32 beams of all 7 base stations, i.e. transmitted in 32×7=224 beams. The paging message may serve a paging group of more than one UE, but transmitting the same paging message in all 224 beams is still relatively high overhead in terms of wasted radio resources (e.g. time-frequency resources) and/or power resources due to redundant transmission of the same paging message in multiple beams and multiple cells.

Instead, in some embodiments described herein, a UE-specific notification is transmitted. The UE-specific notification may be transmitted in a downlink beam pointed in the direction of the UE. The UE-specific notification may be transmitted when the UE is in a power saving state. The UE-specific notification may be a paging message specific to the UE that indicates that there is downlink data for transmission to that UE. However, more generally the UE-specific notification may be any type of downlink notification for a UE, e.g. as described herein. The notification may include downlink beam information, e.g. information pertaining to the direction of a downlink beam, such as the downlink beam from the base station to the UE.

Because a UE-specific notification may be transmitted in a single downlink beam pointed in the direction of the UE, it may be possible to reduce the amount of radio resources (e.g. time-frequency resources) and/or power resources compared to having to repeat transmission of a same paging message in multiple beams and multiple cells (e.g. by multiple base stations).

In some embodiments, the UE-specific downlink notification in the power saving state may be decoupled from the transmission of a synchronization signal block (SSB). In some embodiments, the UE-specific downlink notification is “UE-specific” in one, some, or all of the following ways:

(1) The notification is transmitted to the UE in a downlink beam pointed in the direction of that UE.
(2) The downlink time-frequency resource in the beam in which the notification is sent is dedicated to that UE.
(3) The content of the notification is specific to the UE. As an example, the content of the notification may be an indication that there is downlink data for transmission to that UE. An interaction between that UE and network may be required before the downlink data transmission, e.g., channel measurement feedback, uplink reference signaling transmission, beam based information exchange, service request, etc.

In some embodiments, the downlink notification may trigger a power mode change between different power/energy usage levels for the UE. The power mode change may be within the same power state, e.g. if within a single power state (such as within a single power saving state) there are several power modes each with different power consumption levels.

In some embodiments, to enhance the reception reliability of the downlink notification, more than one base station may transmit the downlink notification to that UE in an individual beam each pointed in the direction of that UE.

In one embodiment, a method performed by an apparatus (e.g. a UE) is provided. The method may include receiving a notification during a notification opportunity at a time-frequency resource. The notification may be received when the apparatus is in a power saving state. The notification may be apparatus-specific. The method may further include decoding, by the apparatus, information carried by the notification. The information carried by the notification may possibly include downlink beam information. In some embodiments, a downlink beam carrying the notification may be pointed in the direction of the apparatus based on the position of the apparatus. In some embodiments, the downlink beam is not part of a downlink beam sweeping pattern. In some embodiments, prior to receiving the downlink beam the method may include synchronizing with the network using at least one synchronization signal in a beam of the downlink beam sweeping pattern. An apparatus to perform the methods is also disclosed herein.

In one embodiment, a method performed by a network device (e.g. a base station) is provided. The method may include obtaining a position of an apparatus in a network. The method may further include, during a notification opportunity, transmitting a notification for the apparatus at a time-frequency resource in a downlink beam pointed in the direction of the apparatus. The direction of the downlink beam may be based on the position of the apparatus. The information carried by the notification may possibly include downlink beam information. In some embodiments, the downlink beam information may be for, e.g., active beam update or switching within one base station, or among two base stations, and/or network information such as carrier frequencies, system bandwidth(s), orientations of the base stations, the info on base station switching between TN and NTN, etc. A network device to perform the methods is also disclosed herein.

### BRIEF DESCRIPTION OF THE DRAWINGS

Embodiments will be described, by way of example only, with reference to the accompanying figures wherein:

FIG. 1 is a network diagram of an example communication system;

FIG. 2 is a block diagram of an example electronic device;

FIG. 3 is a block diagram of another example electronic device;

FIG. 4 is a block diagram of example component modules;

FIG. 5 is a block diagram of an example user equipment and base station;

FIG. 6 illustrates resources for synchronization and group paging, according to one embodiment;

FIGS. 7 to 13 illustrate examples of UE-specific notifications, according to various embodiments;

FIG. 14 illustrates two example beam sweeping patterns; and

FIGS. 15 to 16 are methods according to various embodiments.

### DETAILED DESCRIPTION

For illustrative purposes, specific example embodiments will now be explained in greater detail below in conjunction with the figures.

### Example Communication Systems and Devices

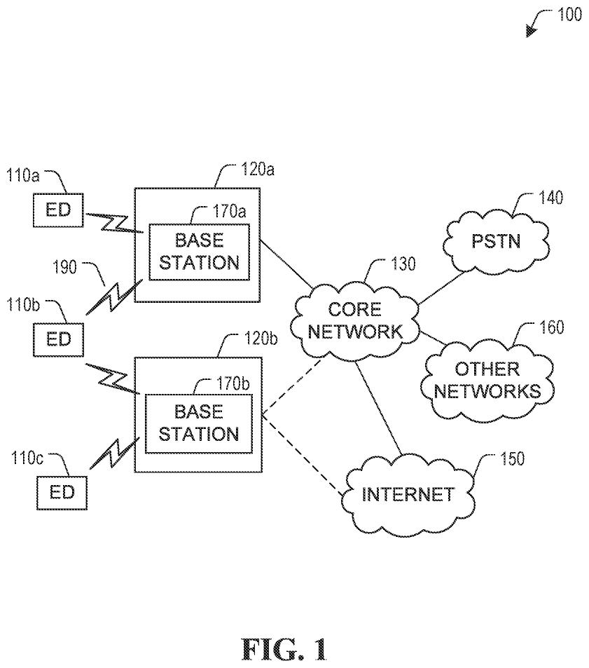

FIG. 1 illustrates an example communication system 100. In general, the communication system 100 enables multiple wireless or wired elements to communicate data and other content. The purpose of the communication system 100 may be to provide content, such as voice, data, video, and/or text, via broadcast, narrowcast, user device to user device, etc. The communication system 100 may operate by sharing resources, such as bandwidth.

In this example, the communication system 100 includes electronic devices (ED) 110a-110c, radio access networks (RANs) 120a-120b, a core network 130, a public switched telephone network (PSTN) 140, the internet 150, and other networks 160. Although certain numbers of these components or elements are shown in FIG. 1, any reasonable number of these components or elements may be included in the communication system 100.

The EDs 110a-110c are configured to operate, communicate, or both, in the communication system 100. For example, the EDs 110a-110c are configured to transmit, receive, or both via wireless or wired communication channels. Each ED 110a-110c represents any suitable end user device for wireless operation and may include such devices (or may be referred to) as a user equipment/device (UE), wireless transmit/receive unit (WTRU), mobile station, fixed or mobile subscriber unit, cellular telephone, station (STA), machine type communication (MTC) device, personal digital assistant (PDA), smartphone, laptop, computer, tablet, wireless sensor, or consumer electronics device.

In FIG. 1, the RANs 120a-120b include base stations 170a-170b, respectively. Each base station 170a-170b is configured to wirelessly interface with one or more of the EDs 110a-110c to enable access to any other base station 170a-170b, the core network 130, the PSTN 140, the internet 150, and/or the other networks 160. For example, the base stations 170a-170b may include (or be) one or more of several well-known devices, such as a base transceiver station (BTS), a Node-B (NodeB), an evolved NodeB (eNodeB or eNB), a Home eNodeB, a gNodeB, a transmission point (TP), a site controller, an access point (AP), or a wireless router. Any ED 110a-110c may be alternatively or additionally configured to interface, access, or communicate with any other base station 170a-170b, the internet 150, the core network 130, the PSTN 140, the other networks 160, or any combination of the preceding. The communication system 100 may include RANs, such as RAN 120b, wherein the corresponding base station 170b accesses the core network 130 via the internet 150.

The EDs 110a-110c and base stations 170a-170b are examples of communication equipment that can be configured to implement some or all of the functionality and/or embodiments described herein. In the embodiment shown in FIG. 1, the base station 170a forms part of the RAN 120a, which may include other base stations, base station controller(s) (BSC), radio network controller(s) (RNC), relay nodes, elements, and/or devices. Any base station 170a, 170b may be a single element, as shown, or multiple elements, distributed in the corresponding RAN, or otherwise. Also, the base station 170b forms part of the RAN 120b, which may include other base stations, elements, and/or devices. Each base station 170a-170b transmits and/or receives wireless signals within a particular geographic region or area, sometimes referred to as a “cell” or “coverage area”. A cell may be further divided into cell sectors, and a base station 170a-170b may, for example, employ multiple transceivers to provide service to multiple sectors. In some embodiments there may be established pico or femto cells where the radio access technology supports such. In some embodiments, multiple transceivers could be used for each cell, for example using multiple-input multiple-output (MIMO) technology. The number of RAN 120a-120b shown is exemplary only. Any number of RAN may be contemplated when devising the communication system 100.

The base stations 170a-170b communicate with one or more of the EDs 110a-110c over one or more air interfaces 190 using wireless communication links e.g. radio frequency (RF), microwave, infrared (IR), etc. The air interfaces 190 may utilize any suitable radio access technology. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190.

A base station 170a-170b may implement Universal Mobile Telecommunication System (UMTS) Terrestrial Radio Access (UTRA) to establish an air interface 190 using wideband CDMA (WCDMA). In doing so, the base station 170a-170b may implement protocols such as HSPA, HSPA+ optionally including HSDPA, HSUPA or both. Alternatively, a base station 170a-170b may establish an air interface 190 with Evolved UTMS Terrestrial Radio Access (E-UTRA) using LTE, LTE-A, and/or LTE-B. It is contemplated that the communication system 100 may use multiple channel access functionality, including such schemes as described above. Other radio technologies for implementing air interfaces include IEEE 802.11, 802.15, 802.16, CDMA2000, CDMA2000 1×, CDMA2000 EV-DO, IS-2000, IS-95, IS-856, GSM, EDGE, and GERAN. Other multiple access schemes and wireless protocols may be utilized.

The RANs 120a-120b are in communication with the core network 130 to provide the EDs 110a-110c with various services such as voice, data, and other services. The RANs 120a-120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a-120b or EDs 110a-110c or both, and (ii) other networks (such as the PSTN 140, the internet 150, and the other networks 160). In addition, some or all of the EDs 110a-110c may include functionality for communicating with different wireless networks over different wireless links using different wireless technologies and/or protocols. Instead of wireless communication (or in addition thereto), the EDs may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as IP, TCP, UDP. EDs 110a-110c may be multimode devices capable of operation according to multiple radio access technologies, and incorporate multiple transceivers necessary to support such.

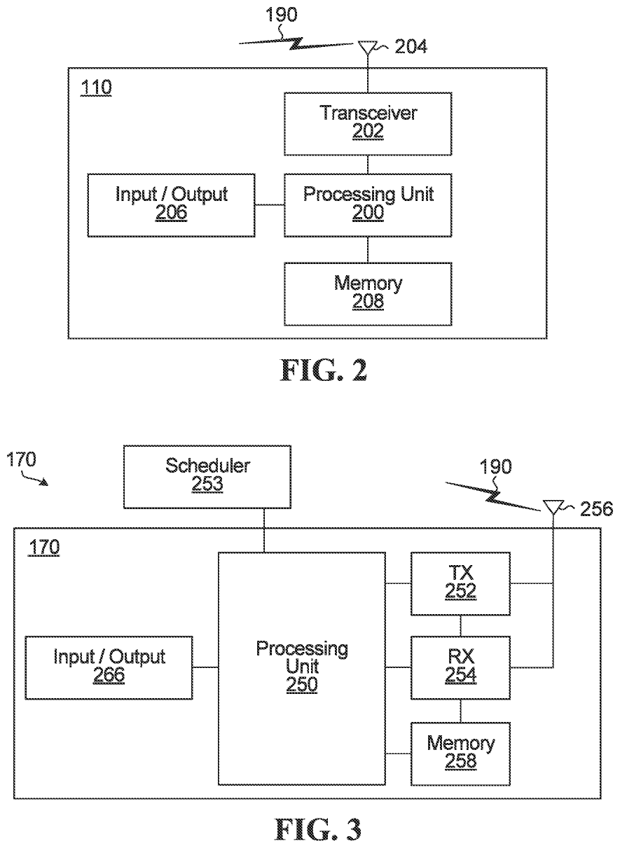

FIGS. 2 and 3 illustrate example devices that may implement the methods and teachings according to this disclosure. In particular, FIG. 2 illustrates an example ED 110, and FIG. 3 illustrates an example base station 170. These components could be used in the communication system 100 or in any other suitable system.

As shown in FIG. 2, the ED 110 includes at least one processing unit 200. The processing unit 200 implements various processing operations of the ED 110. For example, the processing unit 200 could perform signal coding, data processing, power control, input/output processing, or any other functionality enabling the ED 110 to operate in the communication system 100. The processing unit 200 may also be configured to implement some or all of the functionality and/or embodiments described in more detail herein. Each processing unit 200 includes any suitable processing or computing device configured to perform one or more operations. Each processing unit 200 could, for example, include a microprocessor, microcontroller, digital signal processor, field programmable gate array, or application specific integrated circuit.

The ED 110 also includes at least one transceiver 202. The transceiver 202 is configured to modulate data or other content for transmission by at least one antenna 204 or Network Interface Controller (NIC). The transceiver 202 is also configured to demodulate data or other content received by the at least one antenna 204. Each transceiver 202 includes any suitable structure for generating signals for wireless or wired transmission and/or processing signals received wirelessly or by wire. Each antenna 204 includes any suitable structure for transmitting and/or receiving wireless or wired signals. One or multiple transceivers 202 could be used in the ED 110. One or multiple antennas 204 could be used in the ED 110. Although shown as a single functional unit, a transceiver 202 could also be implemented using at least one transmitter and at least one separate receiver.

The ED 110 further includes one or more input/output devices 206 or interfaces (such as a wired interface to the internet 150). The input/output devices 206 permit interaction with a user or other devices in the network. Each input/output device 206 includes any suitable structure for providing information to or receiving information from a user, such as a speaker, microphone, keypad, keyboard, display, or touch screen, including network interface communications.

In addition, the ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by the processing unit(s) 200. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, and the like.

As shown in FIG. 3, the base station 170 includes at least one processing unit 250, at least one transmitter 252, at least one receiver 254, one or more antennas 256, at least one memory 258, and one or more input/output devices or interfaces 266. A transceiver, not shown, may be used instead of the transmitter 252 and receiver 254. A scheduler 253 may be coupled to the processing unit 250. The scheduler 253 may be included within or operated separately from the base station 170. The processing unit 250 implements various processing operations of the base station 170, such as signal coding, data processing, power control, input/output processing, or any other functionality. The processing unit 250 can also be configured to implement some or all of the functionality and/or embodiments described in more detail herein. Each processing unit 250 includes any suitable processing or computing device configured to perform one or more operations. Each processing unit 250 could, for example, include a microprocessor, microcontroller, digital signal processor, field programmable gate array, or application specific integrated circuit.

Each transmitter 252 includes any suitable structure for generating signals for wireless or wired transmission to one or more EDs or other devices. Each receiver 254 includes any suitable structure for processing signals received wirelessly or by wire from one or more EDs or other devices. Although shown as separate components, at least one transmitter 252 and at least one receiver 254 could be combined into a transceiver. Each antenna 256 includes any suitable structure for transmitting and/or receiving wireless or wired signals. Although a common antenna 256 is shown here as being coupled to both the transmitter 252 and the receiver 254, one or more antennas 256 could be coupled to the transmitter(s) 252, and one or more separate antennas 256 could be coupled to the receiver(s) 254. Each memory 258 includes any suitable volatile and/or non-volatile storage and retrieval device(s) such as those described above in connection to the ED 110. The memory 258 stores instructions and data used, generated, or collected by the base station 170. For example, the memory 258 could store software instructions or modules configured to implement some or all of the functionality and/or embodiments described above and that are executed by the processing unit(s) 250.

Each input/output device 266 permits interaction with a user or other devices in the network. Each input/output device 266 includes any suitable structure for providing information to or receiving/providing information from a user, including network interface communications.

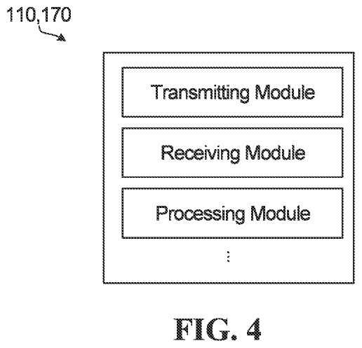

One or more steps of the embodiment methods provided herein may be performed by corresponding units or modules, according to FIG. 4. FIG. 4 illustrates units or modules in a device, such as in ED 110 or base station 170. For example, a signal may be transmitted by a transmitting unit or a transmitting module. A signal may be received by a receiving unit or a receiving module. A signal may be processed by a processing unit or a processing module. The processing module may encompass the units/modules described later, in particular the processor 210 or processor 260. Other units/modules may be included in FIG. 4, but are not shown. The respective units/modules may be hardware, software, or a combination thereof. For instance, one or more of the units/modules may be an integrated circuit, such as field programmable gate arrays (FPGAs) or application-specific integrated circuits (ASICs). It will be appreciated that where the modules are software, they may be retrieved by a processor, in whole or part as needed, individually or together for processing, in single or multiple instances as required, and that the modules themselves may include instructions for further deployment and instantiation.

Additional details regarding the EDs 110 and the base stations 170 are known to those of skill in the art. As such, these details are omitted here for clarity.

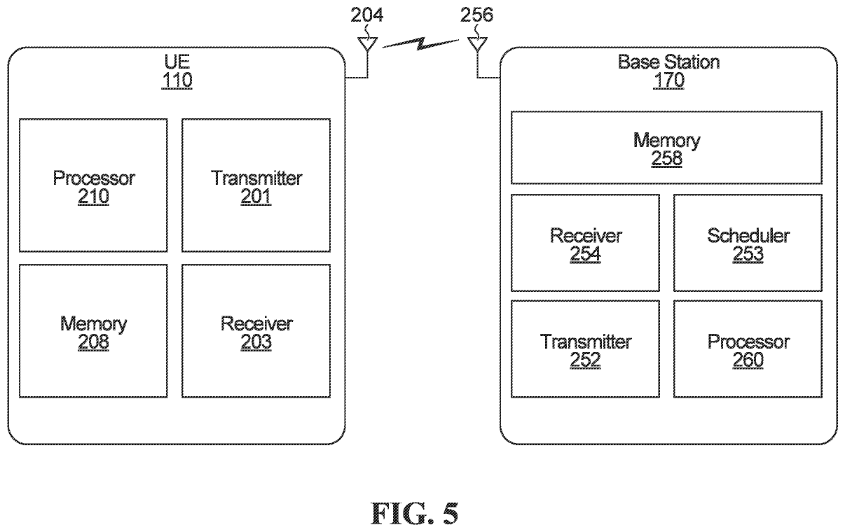

FIG. 5 illustrates another example of an ED 110 and a base station 170. The ED 110 will hereafter be referred to as a user equipment (UE) 110 or apparatus 110.

The base station 170 may be called other names in some implementations, such as a transmit-and-reception point, a transmit-and-receive point (TRP), a base transceiver station, a radio base station, a network node, a network device, a transmit/receive node, a Node B, an evolved NodeB (eNodeB or eNB), a gNB, a relay station, or a remote radio head. In some embodiments, the parts of the base station 170 may be distributed. For example, some of the modules of the base station 170 may be located remote from the equipment housing the antennas of the base station 170, and may be coupled to the equipment housing the antennas over a communication link (not shown). Therefore, in some embodiments, the term base station 170 may also refer to modules on the network side that perform processing operations, such as resource allocation (scheduling), message generation, and encoding/decoding, and that are not necessarily part of the equipment housing the antennas of the base station 170. The modules may also be coupled to other base stations. In some embodiments, the base station 170 may actually be a plurality of base stations that are operating together to serve the UE 110, e.g. through coordinated multipoint transmissions. Also, the term “base station” is used herein to refer to a network device, i.e. a device on the network side.

The base station 170 includes a transmitter 252 and a receiver 254 coupled to one or more antennas 256. Only one antenna 256 is illustrated. One, some, or all of the antennas may alternatively be panels. The transmitter 252 and the receiver 254 may be integrated as a transceiver. The base station 170 further includes a processor 260 for performing operations including those related to preparing a transmission for downlink transmission to the UE 110, and those related to processing uplink transmissions received from the UE 110. Processing operations related to preparing a transmission for downlink transmission may include operations such as encoding, modulating, precoding (e.g. MIMO precoding), beamforming, and generating the symbols for downlink transmission. Processing operations related to processing uplink transmissions may include operations such as demodulating and decoding the received symbols, and beamforming. The processor 260 may also perform operations relating to network access (e.g. initial access) and/or downlink synchronization, such as generating the content of the synchronization signal blocks (SSBs) disclosed herein, generating the system information, etc. In some embodiments, the processor 260 also generates the UE-specific notification described herein, which may be scheduled for transmission by scheduler 253 in a time-frequency resource with the UE-specific downlink beam. In some embodiments, the processor 260 may generate signaling to configure one or more parameters of the UE 110. Any signaling generated by the processor 260 is sent by the transmitter 252. Note that “signaling”, as used herein, may alternatively be called control signaling. Dynamic signaling may be sent in a control channel (e.g. a physical downlink control channel (PDCCH)), and static or semi-static higher layer signaling may be included in a packet transmitted in a data channel (e.g. in a physical downlink shared channel (PDSCH)).

The base station 170 further includes a scheduler 253, which may schedule uplink and downlink transmissions, including scheduling grants and/or may configure scheduling free (“grant-free”) resources. In some embodiments, the scheduler 253 may generate some or all of the signaling or UE-specific notification messages described as being generated by the processor 260. The base station 100 further includes a memory 258 for storing information and data.

Although not illustrated, the processor 260 may form part of the transmitter 252 and/or receiver 254. Also, although not illustrated, the processor 260 may implement the scheduler 253.

The processor 260, the scheduler 253, and the processing components of the transmitter 252 and receiver 254 may each be implemented by the same or different one or more processors that are configured to execute instructions stored in a memory (e.g. in memory 258). Alternatively, some or all of the processor 260, the scheduler 253, and the processing components of the transmitter 252 and receiver 254 may be implemented using dedicated circuitry, such as a programmed field-programmable gate array (FPGA), a graphical processing unit (GPU), or an application-specific integrated circuit (ASIC).

The UE 110 also includes a transmitter 201 and a receiver 203 coupled to one or more antennas 204. Only one antenna 204 is illustrated. One, some, or all of the antennas may alternatively be panels. The transmitter 201 and the receiver 203 may be integrated as a transceiver, e.g. transceiver 202 of FIG. 2. The UE 110 further includes a processor 210 for performing operations including those related to preparing a transmission for uplink transmission to the base station 170, and those related to processing downlink transmissions received from the base station 170. Processing operations related to preparing a transmission for uplink transmission may include operations such as encoding, modulating, and generating the symbols for transmission. Processing operations related to processing downlink transmissions may include demodulating and decoding the received symbols. Depending upon the embodiment, a downlink transmission may be received by the receiver 203, and the processor 210 may extract signaling from the downlink transmission (e.g. by decoding the signaling). A UE-specific notification may be sent in the signaling and/or as part of a downlink data transmission (e.g. in a received UE-specific downlink beam), and the processor 210 may extract such a notification, e.g. by decoding the bits carrying the notification to obtain the information carried by the notification. In some embodiments, the processor 210 may perform operations relating to network access (e.g. initial access) and/or downlink synchronization, such as operations relating to detecting a synchronization sequence, decoding and obtaining the system information, etc. In some embodiments, the processor 210 determines the scheduling of uplink and downlink transmissions, which may be based on signaling received by the UE 110 that originated from the scheduler 253 of the base station 170.

Although not illustrated, the processor 210 may form part of the transmitter 201 and/or receiver 203. The UE 110 further includes a memory 208 for storing information and data.

The processor 210, and the processing components of the transmitter 201 and receiver 203 may each be implemented by the same or different one or more processors that are configured to execute instructions stored in a memory (e.g. in memory 208). Alternatively, some or all of the processor 210, and the processing components of the transmitter 201 and receiver 203 may be implemented using dedicated circuitry, such as a FPGA, a GPU, or an ASIC.

The base station 170 and the UE 110 may include other components, but these have been omitted for the sake of clarity.

### Paging Messages and Beamforming

In some embodiments, a downlink beamforming method may be implemented by the base station 170 in which the base station 170 directs a downlink transmission in a particular direction, e.g. by performing signal processing that causes the transmitted signals from a plurality of antenna elements to form a signal beam towards the particular direction. A beam transmitted by base station 170 using beamforming typically has a narrow beam width and does not cover the whole coverage area of the base station 170. However, a UE at any location within the coverage area of the base station 170 may need to synchronize and connect to the network, e.g. upon initial access or when the UE in a power saving state wakes up to receive a paging message. Therefore, in some embodiments a synchronization signal (SS) burst is periodically transmitted by the base station 170 during which the base station 170 performs beam sweeping. During the SS burst, a plurality of beams are transmitted, each at a respective different direction and each at a respective different time (e.g. each at a respective different time slot), in order to cover the coverage area of the base station 170. A different synchronization signal block (SSB) is transmitted in each beam. A UE may synchronize and obtain system information using the SSB in the beam that is strongest (or strong enough) for that UE. In some embodiments, paging is implemented as follows. During a paging occasion (PO) there is a link between each SSB transmitted in each beam and a corresponding paging message also transmitted at a later time in that same beam of the beam sweeping pattern, e.g. in a later time slot corresponding to that beam in the pattern. In some embodiments, a paging radio network temporary identifier (P-RNTI) may be used by a UE or a group of UEs to decode paging message scheduling information on a physical downlink control channel (PDCCH). The PDCCH for the paging may be configured (e.g. in system information), including configuring the time-frequency resource or PDCCH search space to transmit the paging message scheduling or the downlink control information (DCI). The paging message scheduling information (or the DCI) indicates a time-frequency resource and other transmission parameters for a physical downlink shared channel (PDSCH) to transmit the paging message. The paging message lists one or more UEs in the paging group for which there is downlink data to come. Therefore, the paging message may be referred to as a group paging message because it is not specific to one UE. A UE may be identified in the group paging message using its UE identification (ID).

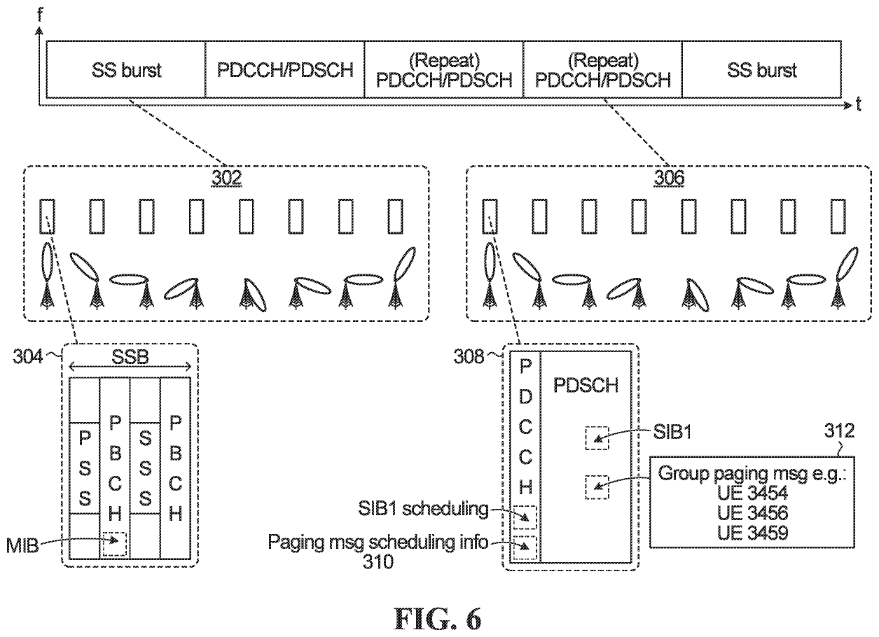

For example, FIG. 6 illustrates two SS bursts in a portion of time-frequency resources. In some embodiments, a SS burst may span twenty resource blocks in the frequency domain and 5 ms in the time domain, and there may be 20 ms between the start of adjacent SS bursts. In each SSburst, beam sweeping is performed according to a pattern that repeats over and over again, e.g. with a periodicity of 2 ms. An example pattern is illustrated at 302 in which the beam sweeping occurs in a counter clockwise pattern. In each beam in the pattern, a respective SSB is transmitted. The SSB transmitted in the first beam in the beam sweeping pattern is shown at 304. In the illustrated example, the SSB block is four symbols and includes a primary synchronization signal (PSS), a secondary synchronization signal (SSS), and a physical broadcast channel (PBCH). The PBCH carries a master information block (MIB) that indicates the time-frequency location for a PDCCH that includes the downlink control information (DCI) to schedule transmission of a system information block SIB 1. The SIB 1 scheduled in a PDSCH may include a configuration for paging comprising paging parameters and the PDCCH monitoring occasions for paging. The beam sweeping pattern may continue between adjacent SS bursts, with each beam in the pattern transmitting a respective PDCCH and PDSCH. For example, another instance of the repeating beam sweeping pattern is shown at 306. This instance of the beam sweeping pattern is interposed between adjacent SS bursts, and a respective PDCCH and PDSCH is sent in each beam. The PDCCH and PDSCH transmitted in the first beam in the beam sweeping pattern is shown at 308. During a paging occasion (PO), the PDCCH includes paging message scheduling information 310 that schedules a group paging message in the PDSCH. An example group paging message is shown at 312. In the example group paging message, it is indicated that there is a downlink data transmission for three UEs identified as UE 3454, UE 3456, and UE 3459. Note that in some embodiments a DCI whose CRC is scrambled by P-RNTI is identified as a paging indication for one or multiple UEs in a PO (or paging PDCCH monitoring occasion), where the DCI includes the paging scheduling information for a PDSCH that carries the paging message.

In operation, a UE in a power saving state may need to synchronize to the network and obtain a paging message, e.g. in a PO during the wake-up portion of a discontinuous reception (DRX) cycle. The UE searches for the beam in the beam sweeping pattern having the strongest (or strong enough) signal and uses the SSB in that beam to downlink synchronize to the network and obtain system information. The system information, such as SIB 1, may be used by the UE to determine the paging frame (PF) and PO.

In some embodiments, the PDCCH and PDSCH are sent in the same beam in the pattern (at a later time, but prior to the next SS burst). The UE (or UEs) in its (or their) PO(s) may expect a paging indication by a DCI (whose CRC scrambled by P-RNTI) in the PDCCH and can receive in the PDSCH the group paging message 312. The UE reads the group paging message 312 to determine if there is downlink data for transmission to the UE. If there is a downlink data transmission for the UE, the UE prepares for the downlink data transmission, which may involve entering an increased power mode (with more active transmission, reception, and/or required measurement, for example). Note that in a power saving state, there may exist several operating modes, alternatively referred to as power modes, each with different power consumption levels. For example, a UE in a power saving state may have DRX periods in which DRX-on period (wake-up period) may be in an enhanced (or relatively higher) power mode and DRX-off period (sleep period) may be in a low or default power mode.

The benefit of the embodiment described above in relation to FIG. 6 is that the group paging message 312 is accessible via any beam in the beam sweeping pattern, and so the location of the UE within the radio access network (RAN) does not need to be known by the network. However, the technical drawback is that the overhead relating to paging may be large. For example, assume the network wants to send a group paging message identifying a downlink data transmission for UE 110. The network does not know the location of UE 110, except that the network does know generally that UE 110 is present in a particular network area, e.g. a particular RAN tracking area. The RAN tracking area is covered by 7 cells, where each cell is served by a different base station, and each base station implements a beam sweeping pattern involving 32 different beams. This means that the group paging message identifying UE 110 will need to be transmitted in all 32 beams of all 7 base stations, i.e. transmitted in 32×7=224 beams. Transmitting the same group paging message in all 224 beams is a waste of radio resources (e.g. time-frequency resources) and/or power resources. Also, note that one group paging message may serve one or multiple UEs having downlink data, but usually not more than about 50 UEs.

To address the problem above, in some other embodiments described below a UE-specific notification is instead transmitted in a downlink beam pointed in the direction of the UE. The UE-specific notification is a UE-specific downlink notification. The UE-specific notification may be a paging message specific to the UE that indicates that there is a downlink data transmission for that UE. Because a UE-specific notification is transmitted in a single downlink beam pointed in the direction of the UE, it may be possible to reduce the amount of radio resources (e.g. time-frequency resources) and/or power resources compared to having to repeat transmission of a same group paging message in all beams of all cells in the RAN, like what is done in the FIG. 6 embodiment. It may also be possible to reduce latency in the downlink because of the reduction in or elimination of redundant group paging messages, which may free up time-frequency resources to more promptly transmit other signaling and/or other data in the downlink.

### UE-Specific Downlink Notification

As described above, in some embodiments a group paging message is not transmitted in the downlink, but rather for each UE requiring a downlink notification, a UE-specific notification is transmitted to that UE. In some embodiments, transmission of the notification is “UE-specific” in one, some, or all of the following ways:

(1) The notification is transmitted to the UE in a downlink beam pointed in the direction of that UE, e.g. the downlink beam is a narrow beam (rather than an omnidirectional or wide beam) pointed in the direction of the UE based on the positioning information of the UE.
(2) The downlink time-frequency resource in which the notification is sent in the beam is dedicated to that UE, e.g. the UE independently decodes and processes the notification.
(3) The content of the notification is specific to the UE. As an example, the content of the notification may bean indication that there is downlink data for transmission to that UE. An interaction between that UE and network may be required before the downlink data transmission, e.g., channel measurement feedback, uplink reference signaling transmission, beam based information exchange, service request, etc.

In some embodiments, the downlink notification may trigger a power mode change between different power/energy usage levels for the UE. The power mode change may be within the same power state, e.g. if within a single power state (such as within a single power saving state) there are several power modes each with different power consumption levels.

In some embodiments, to enhance the reception reliability of the downlink notification, more than one base station may transmit the downlink notification to that UE in an individual beam each pointed in the direction of that UE.

Note that if spatial diversity is implemented by transmitting different beams on the same time-frequency resources but in different directions, then the time-frequency resources may overlap for multiple different UEs, but in each UE-specific beam those time-frequency resources may be dedicated to that UE. Also, in some embodiments the actual content of the notification may not necessarily be unique to the UE, e.g. if the notification is a disaster warning being unicast to all UEs in a particular area via UE-specific notifications. In some embodiments, the UE specific downlink notification is different from a group-based paging message in terms of format, context and encoding, e.g. the UE specific downlink notification information (or message) may utilize UE-specific independent encoding. In other embodiments, the UE-specific beam can be narrow (e.g., beamforming) or wide (e.g., omnidirectional), which can be configurable for the UE specific notification or paging.

To point the downlink beam in the direction of a particular UE, that UE's position must be known by the network. In some embodiments, the UE's position maybe expressed in terms of beam direction from or in relation to a particular base station in the network. In some embodiments, the UE's position may be expressed in terms of range and/or location direction and/or moving direction. In some embodiments, the UE's position may also or instead be expressed in terms of beam angular information (BAI), such as the angle of the beam in terms of azimuth angle and/or zenith angle (such as angle from the zenith) and/or (x, y, z) coordinates in relation to a base station, possibly using the base station as a reference point or origin. The UE's position may be referred to as positioning information. A non-exhaustive list of example ways in which a UE's position may be determined is as follows:
Positioning sensing by the base station 170, e.g. by the base station 170 using radio wave measurements (e.g. radar), and/or acoustic measurements (echolocation), and/or detecting Wi-Fi signals, and/or lidar measurements, etc. For example, base station 170 performs a beam sweep of radio waves (e.g. radar) and receives a reflection back from a particular direction having a strong reflective signal. The fact that the reflection has a relatively strong signal is interpreted by the base station 170 as the presence of a UE, and the direction of reflection indicates the beam direction of the UE relative to the base station 170. The base station 170 then determines which UE is present in that direction, e.g. based on what UE is expected to be there, or based on what UE was recently present in that vicinity, or through another method, e.g. the base station 170 transmitting a request for the UE ID in that beam direction and in response the UE transmitting its UE ID to the base station 170.
Tracking a UE's previous location(s) and, based at least on that tracking data, predicting where the UE will be next, e.g. using artificial intelligence (AI), such as a machine learning algorithm in which the past locations of a UE are input into a trained machine learning algorithm that returns a prediction of the future or current location of that UE. In general, AI may be used to determine the position of a UE, e.g. via supervised or unsupervised learning. The AI may consider many different factors, e.g. the UE's last location, time of day, weather, traffic patterns etc. In one embodiment, a training set may be established in which each sample of the training set includes a known location of a UE and the known value of each input factor associated with that known location, e.g. the UE's previous location, the time of day, the day, sensor measurements from the UE, such as the speed at which the UE was traveling when it was last connected to the network, the angle of the UE when it was last connected to the network, etc. Training may be performed using the training set, and then the trained algorithm used to predict UE position given one, some, or all of the input factors.
A UE periodically transmits a signal to the base station 170 (e.g. in reply to an interrogator signal), where the contents and/or strength and/or direction of the signal is indicative of the position of the UE.
A UE senses its environment, e.g. using radio wave measurements (e.g. radar), and/or acoustic measurements (echolocation), and/or detecting Wi-Fi signals, and/or lidar measurements, etc. The results of the sensing measurements provide an indication of the environment surrounding the UE. Information relating to the environment is then transmitted to the base station 170 and is used by the network to estimate the position of the UE.
The use of positioning reference signals, e.g. the UE transmits a positioning reference signal (PRS) to each of a plurality of base stations, and the network uses the known location of those base stations and the time difference between the times at which each PRS was received in order to estimate the position of the UE.
GPS coordinates of the UE are transmitted to the base station 170, and the GPS coordinates are used to determine the position of the UE.
Reporting information in which the UE periodically transmits information indicative of its position to the base station.

Note that above positioning or sensing schemes may be performed in either in-band (same as the wireless access link) frequency bands or out-band (different from the wireless access link) frequency bands. Other ways not indicated above may also or instead be used to determine the position of the UE.

Once the position of the UE is determined, the base station 170 may transmit a downlink beam pointed in the direction of that UE using beamforming. The beam direction may be the same as or different from a beam direction in a beam sweeping pattern. The beam transmitted to the UE may be called a UE-specific beam because it is a beam specifically pointed in the direction of that UE in order to transmit downlink information to that UE. The UE-specific notification may be transmitted in the UE-specific beam. In one embodiment, the UE-specific beam reuses one beam sweeping pattern of a SSB (e.g., whose direction is pointing closely to the UE), but the notification is UE specific where the notification may include the information exclusive for the UE, such as beam updating/switching, network switching, short/public message indication, UE state transition, measurement/report indication, etc.

A UE-specific notification transmitted in a UE-specific beam is not necessarily limited to a UE-specific paging message. The notification may relate to other functions and/or transmit different information. A non-exhaustive list of example UE-specific notifications includes:
A notification of coming data, e.g. a notification that there is downlink data to transmit to the UE, such as a UE-specific paging message; and/or
A notification of other network control information for the UE, such as positioning reporting information, and/or channel measurement reporting information, and/or other reporting information, and/or a beam configuration update, and/or uplink synchronization information, etc.; and/or
An indication that the UE is to switch to a different operating mode, e.g. a different power mode (which may be within a same power state), such as the UE being instructed to switch to an active data transmission and/or reception mode, a half/full duplexing operation indication, etc.; and/or
An indication of public or urgent information, such as a disaster warning, a criminal warning, a public health warning/reminder, etc.

If the downlink notification is a paging indication, then it may be called a data notification.

In some embodiments, the notification may additionally or instead carry downlink beam information. Downlink beam information may include downlink beam direction or subspace. A subspace may be a set of spatial parameters to describe the beam/antenna orientation and direction. Downlink beam direction may pertain to the downlink beam carrying the notification and/or to another downlink beam. Downlink beam direction may be expressed in terms of location direction or BAI, such as the angle of the downlink beam in terms of azimuth angle and/or zenith angle (such as angle from the zenith) and/or (x, y, z) coordinates in relation to a base station, possibly using the base station as a reference point or origin. The downlink beam information may be used by the UE to perform actions such as: transceiver beamforming by the UE, e.g. to generate a receive beam that corresponds to the downlink transmit beam direction; and/or updating the beam tracking of the UE; and/or using the beam information for measurement and potential beam switching; and/or inputting the beam information for UE training or sensing, e.g. to fine-tune the beam information.

In other embodiments, the notification may additionally or instead carry network information. The network information may include information on different types of networks (nearby) such as frequency bands, network bandwidths, the network orientations, active beam related information, and/or network switching criteria or conditions.

Note that for some notifications the actual contents are not specific to the UE, for example, the content of the notification may be e.g., a disaster warning, a criminal event warning, etc., being issued to all UEs in a particular area. Any of these notifications can be sent in a unicast way using the UE-specific notification, or can be sent in a group-cast/multi-cast way using, e.g., special DCI signaling via PDCCH, where a common group notification ID can be configured for a group of users that is used in the DCI.

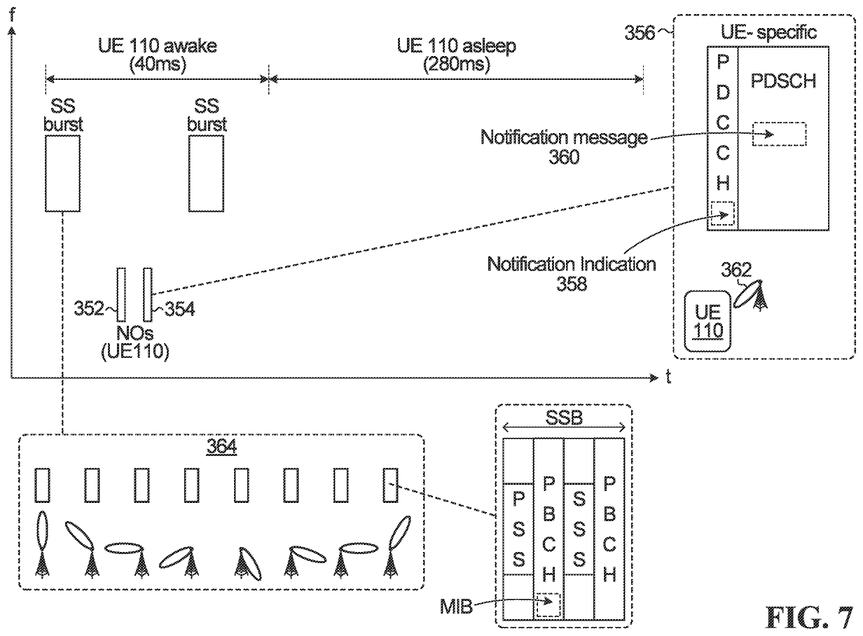

FIG. 7 illustrates an example of a UE-specific notification for UE 110, according to one embodiment. UE 110 has a DRX cycle that includes a 40 ms wake up (“awake”) duration and a 280 ms sleep (“asleep”) duration. The sleep duration is a lower power mode than the awake duration. The awake duration includes an operating mode (e.g. a higher power mode in the same state) during which the UE 110 checks for a UE-specific downlink notification during one or more notification opportunities (NOs). For example, the UE 110 may be in an Inactive or Idle state (e.g. an Inactive or Idle RRC state), or more generally in a power saving state with low power mode, and then wake up during the awake duration to check for a UE-specific downlink notification. Even in the wake up duration the UE may still remain in the power saving state (e.g. in the Inactive or Idle state), but a higher power level may be needed compared to the sleep duration.

Two NOs 352 and 354 are illustrated in FIG. 7. There may be more or fewer NOs in a wake-up duration in each notification period, depending on notification parameter configuration. The NOs 352 and 354 are specific to UE 110. When there is a notification for the UE 110, the notification is transmitted in the downlink in the time-frequency resources associated with the NO. For example, UE-specific time-frequency resources for UE 110 are illustrated at 356. These time-frequency resources are present in the downlink during NO 354 and include a control channel (e.g. a PDCCH, as illustrated), and a data channel (e.g. a PDSCH, as illustrated). The control channel configuration for the notification may be provided by the system information, e.g., SIB 1. For example, system information (e.g. in SIB 1) may provide the location/resources on the PDCCH relating to the notification. The data channel is scheduled by a DCI in the PDCCH control channel. The DCI in the PDCCH control channel includes the scheduling information and the notification indication 358 for the UE 110, where the CRC of the DCI may be scrambled by a UE ID by the base station; thus the notification indication 358 may be obtained at the UE side by unscrambling the UE ID (i.e., only the intended UE can use its ID to detect the DCI correctly and thus obtain the notification indication 358 included in the detected DCI in the PDCCH control channel). In some embodiments, the UE ID in a power saving state may be unique at least over the UE notification tracking area. For example, the UE ID may be an I-RNTI for a UE in Inactive/Idle state, CS-RNTI for configured grant transmission, or a predefined/higher-layer signaling configured ID for the notification in the power saving state, etc. In some embodiments, the UE may have more than one ID to perform the notification operations in the power saving state, where these IDs can be predefined and/or higher-layer signaling configured; for example, the UE may have two IDs, one for notification indication used in DCI signaling (e.g., scrambling DCI), and the other for UE identity to uniquely identify the UE in the power saving state.

The notification indication 358 may indicate, to the UE, a coming notification message 360 in the data channel (e.g. PDSCH) scheduled by the DCI signaling in the PDCCH. The notification indication 358 may have zero, one or more bits included in the DCI whose CRC is scrambled by the UE ID. In some embodiments, the notification indication 358 having zero bits in the DCI may simply mean that the UE needs to receive a coming notification in the data channel if the DCI is scrambled by a UE notification ID. The coming notification may be, for example, a paging message for the UE data. If the notification indication 358 has one or more bits in the DCI, then the notification indication 358 may carry more information regarding the notification details such as whether or not a notification message 360 is to come in this NO (if no, the UE might not decode the data channel, thus save the unnecessary processing), and/or any type of common message for multiple UEs and where to handle it (e.g., reception in a common broadcast channel or a group cast/multi-cast channel), etc. Furthermore, or alternatively, in some embodiments the notification indication 358 may indicate to a geo-based (e.g., area/region-based) artificial intelligence (AI) data base or knowledge base to enhance both UE and base station traffic transmission and reception, such as precoding, channel estimation, modulation, timing, synchronization, where the AI data base or knowledge base can be obtained by training and updated over time, and maintained by the network and individual network node (e.g., base station). The information on the AI data base or knowledge base might or might not be transmitted in the UE specific notification message 360; for example, the AI data base or knowledge base may be transmitted by a common control/data channel such as a broadcast or group-cast channel.

The notification indication 358 and the notification message 360 may be present in the same slot or same mini-slot, or in different slots or different mini-slots. A slot or non-slot based data channel (e.g. PDSCH) may be used for transmission of the notification message 360. For a non-slot based transmission, in one embodiment a two, four, and seven OFDM-symbol duration for transmitting the notification message 360 may be supported.

The UE 110 decodes the DCI to obtain the notification indication 358 in the PDCCH and to determine the time-frequency location of the notification message 360 in the downlink data channel, and then (assuming a notification message 360 is indicated) the UE 110 decodes the notification message 360 in the data channel. In some embodiments, the base station may send a notification indication 358 in DCI via the PDCCH to notify the UE of a common message (e.g., warning), that is sent in other channels such as a group-cast or broadcast channel, and possibly not indicate a UE specific notification message 360.

Assuming a notification message 360 is sent, as is the case in FIG. 7, the notification message 360 includes a UE-specific notification, e.g. one of the notifications discussed earlier, such as a notification that there is downlink data to transmit to the UE, and/or an indication that the UE is to switch to a different operating mode, etc. The UE 110 takes the action or actions according to notification message 360, e.g. according to predefined, configured or preconfigured functionality depending on the received notification cause type. For example, if there is downlink data to be transmitted to the UE 110 or an uplink reporting request from the network, the UE 110 will perform the required action, which may involve switching out of a power saving state into another operation state with more power usage (e.g. into RRC connected state), or may involve switching from a low power mode into an enhanced power mode (e.g., within the same power saving state). The other operation state or the enhanced power mode may employ a set of transmission parameters and time-frequency resources that are pre-defined, pre-configured, semi-statically configured, and/or dynamically configured.

In addition to the notification indication, the notification message 360 may indicate more information or parameters that may be specific to the UE 110. For example, one, some, or all of the following may be indicated in the notification message 360 and specific to the UE 110: timing information for uplink synchronization, power control parameters, paging/notification indication ID, UE ID, information for usage or change of frequency band, channel bandwidth, numerology, power control and usage, channel measurement/reporting, follow-up operations from UE side, etc. Furthermore, or alternatively, the notification indication may indicate to a geo-based (e.g., area/region-based) AI data base or knowledge base to enhance both UE and base station traffic transmission and reception for performance optimization in the specific area, such as precoding, channel estimation, modulation, timing, synchronization, where the AI data base or knowledge base can be obtained by training and updated over time, and maintained by the network and individual network node (e.g., base station). The UE specific notification message 360 may include the AI data base or knowledge, and/or part of or the entire AI data base or knowledge base may be transmitted by a common control/data channel such as a broadcast or group-cast channel.

Subsequent to the UE 110 receiving the notification message 360, the UE may transmit a response, e.g. a confirmation or request a service including for downlink and/or uplink, to the base station 170. Additionally, or alternatively, the UE 110 may perform another action that inherently indicates to the base station 170 that the notification message 360 was successfully received. For example, if the notification message 360 includes an indication that there is a downlink data for transmission to the UE 110, then the UE 110 may prepare for data reception, which may involve sending an uplink transmission to the base station 170, thereby inherently indicating to the base station 170 that the UE 110 successfully received the notification message 360.

In some embodiments, if the notification message 360 includes an indication that there is downlink data for transmission to the UE 110, then the UE 110 might or might not transition from an RRC Inactive or RRC Idle state into an RRC Connected state depending upon any instruction from base station, if any.

Because the position of the UE 110 is known by the network, e.g. via one of the methods explained earlier, the downlink transmission in each NO 352 and 354 is transmitted to the UE 110 in a downlink beam specifically pointed in the direction of the UE 110, e.g. as shown at 362.

In the example in FIG. 7, the NOs 352 and 354 are decoupled from the SS bursts and SSBs. A beam sweeping pattern is still transmitted in a SS burst, e.g. as shown at 364, with each beam having a respective SSB, like in the FIG. 6 embodiment, but there is no notification beam associated with each SSB in each beam. The notification information/message is not transmitted in a beam of the beam sweeping pattern within the SSB. Instead, paging and other downlink notifications for UEs are instead sent in UE-specific beams during UE-specific NOs. The direction of the UE-specific downlink beam is not fixed, but changes based on the position of the UE. As the UE 110 moves, the direction/angle of the UE-specific beam moves. In general, the UE-specific beam more accurately points to the UE 110 compared to a fixed beam part of a beam sweeping pattern in a SS burst.

In operation, in some embodiments, the UE 110 monitors the control channel (e.g. PDCCH illustrated in FIG. 7) at the notification occasion (NO), sometimes instead called a paging occasion (PO) for data notification. The time-frequency resources of the control channel may be configured for a NO by, e.g., SIB1 and/or RRC configured during initial network entry. The UE 110 tries to decode the DCI in the control channel to obtain the notification indication 358, as well as to obtain the scheduled time-frequency resources (and other relevant transmission parameters) for the notification message 360 in the data channel (e.g. PDSCH in FIG. 7). In some embodiments, the notification indication 358 and the scheduled resources that schedule the notification message 360 are included in different element fields in DCI in the control channel. Both the control channel (e.g. PDCCH in FIG. 7) and data channel (e.g. PDSCH channel in FIG. 7) are in the same beam pointing in the direction to the UE 110. Assuming a notification message 360 is present, the UE 110 then decodes the notification message 360 at the time-frequency location in the data channel that was indicated/scheduled by the DCI. The UE 110 then takes appropriate action based on the notification message 360. In some embodiments, the DCI is scrambled with a UE ID/notification ID (e.g., for unicast transmission if the ID is unique, or groupcast transmission if the ID is group based). The DCI may have multiple fields including one for the notification indication 358 and a few fields for scheduling (time, frequency resource, MCS, etc., allocation) of the downlink data channel (e.g. PDSCH) and/or for scheduling of an uplink data channel (e.g. PUSCH). The notification indication 358 does not act as scheduling signaling, but rather is an indication to describe the notification related information. In some embodiments, a notification indication 358 of zero bits means there is not any notification indication field in the DCI, but as the DCI is scrambled by a notification ID (or UE ID) anyway, it may imply only one thing for the notification indication, e.g.: there is a downlink notification message for the UE to receive.

In some embodiments, the same notification may be transmitted in multiple NOs (e.g. the notification message 360 transmitted in NO 354 may be the same notification message as was transmitted in NO 352), or different NOs may carry different notifications for the UE.

In FIG. 7, the time-frequency resources of the NOs are different from and non-overlapping with the time-frequency resources on which the SS bursts are sent, and the NOs are not part of a beam sweeping pattern, but are specific to individual UEs. In the example in FIG. 7, upon waking up in a wake-up duration, UE 110 would first use a SS burst to synchronize with the network in the downlink prior to a NO, e.g. prior to NO 352. In alternative embodiments, the UE 110 may already be or remain synchronized for downlink and/or uplink with the network in the power saving state and therefore might not need to use a SS burst to synchronize with the network in the downlink prior to a NO.

The time-frequency location of each of NOs 352 and 354 may be predefined or configurable, but in any case known by UE 110. That is, in the wake-up duration UE 110 knows which particular point in time (e.g. which time slot) and which frequency (e.g. which resource blocks and/or bandwidth part (BWP)) to listen to the control channel for notification indication 358. In some embodiments, the number of NOs during a wake-up duration is configurable, possibly on a UE-specific basis. For example, higher mobility UEs may have more NOs than lower mobility UEs. As another example, a static and low cost UE close to the base station may be configured with one NO in each DRX cycle, whereas a fast-moving UE may be configured with more than one NO in each DRX cycle. In some embodiments, the duration of a NO may be configured, possibly on a UE-specific basis, and possibly on a semi-static and/or dynamic basis. For example, in FIG. 7 each NO 352 and 354 is approximately 5 ms in duration, but a NO could be longer or shorter. Different NOs may have different time durations. In general, a NO is one or more symbols in duration, e.g. possibly one or more time slots or one or more subframes or one or more transmission time units (TTUs).

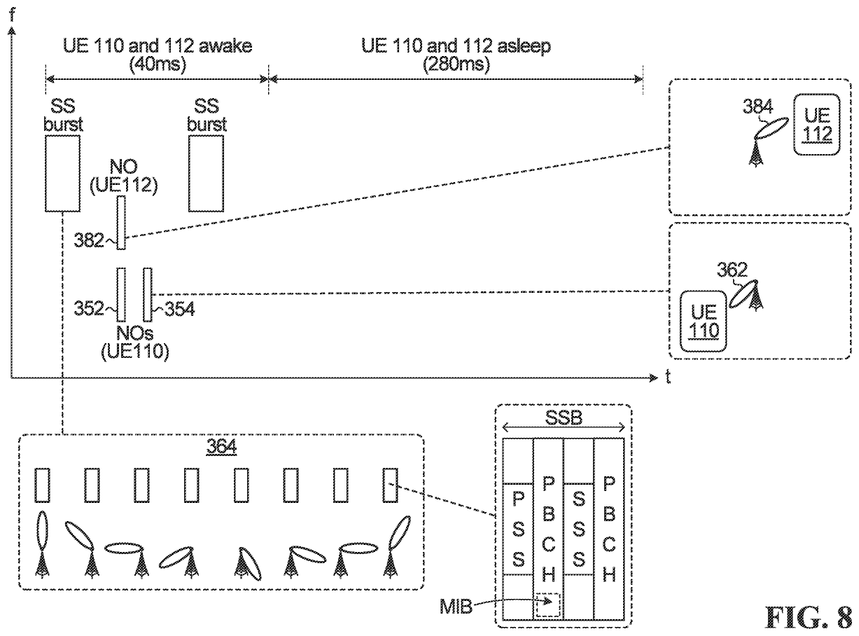

FIG. 8 illustrates a variation of FIG. 7 in which there are two UEs 110 and 112. UE 110 has two NOs 352 and 354 during a wake-up duration, whereas UE 112 only has one NO 382. The number of NOs for each UE is configurable. At each NO for each UE, a UE-specific downlink beam is transmitted in the direction of that UE. UEs 110 and 112 are in different positions in relation to base station 170 and so different beamforming is applied to beamform the beam for UE 110 in the direction of UE 110 (e.g. as shown at 362) and to beamform the beam for UE 112 in the direction of UE 112 (e.g. as shown at 384). In FIG. 8, each NO for each UE is at a separate non-overlapping time-frequency location dedicated to that UE. Alternatively, the time-frequency resources for NO 382 may overlap with the time-frequency resources for NO 352 or 354 because beam 384 is non-overlapping with beam 362. However, within the UE-specific beam the time-frequency resources on that UE-specific beam are dedicated to the UE to which the beam is being transmitted.

In FIG. 8, the time-frequency resources for NO 382 are aligned in time with the time-frequency resources for NO 352, although NO 382 and 352 are at different frequencies. In general, there does not have to be time alignment between NOs for different UEs. Also, in FIG. 8, UEs 110 and 112 have a sleep/awake cycle that is the same duration and that is aligned in time. However, in general, different UEs may have sleep/awake cycles that may be of different durations and/or that might not be aligned in time.

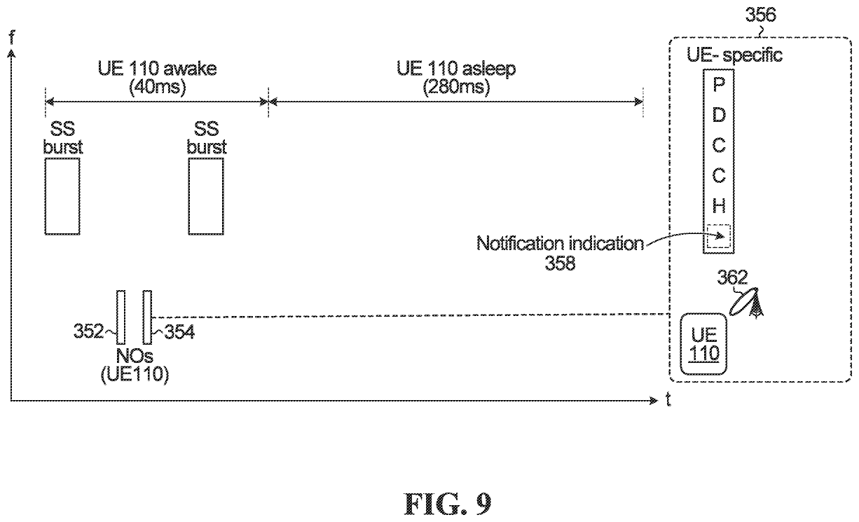

FIG. 9 illustrates a variation of FIG. 7 in which there is no data channel (e.g. no PDSCH) transmitted in the UE-specific beam during a NO. The notification indication 358 carries the notification itself, rather than scheduling a separate notification message 360 in a data channel. The variation illustrated in FIG. 9 may be most applicable when a notification to be sent to the UE 110 is small in size, e.g. a short notification message and/or a notification message that has a relatively small number of bits. The small number of bits may indicate whether there is downlink data for transmission to the UE 110, and/or may indicate that the UE 110 is to switch to a lower or higher power operating mode, etc. In FIG. 9, the notification indication 358 may function as both notification indication and the notification message 360 because the content of the notification itself is transmitted in the notification indication 358. In other embodiments, the notification indication 358 may indicate a common or public message to the UE, where the common or public message (e.g., natural disaster warning, health warning, criminal warning, etc.) is not transmitted in the UE specific notification message but is transmitted (or to be transmitted) in some common control or data channel, such as system broadcast or group-cast channel.

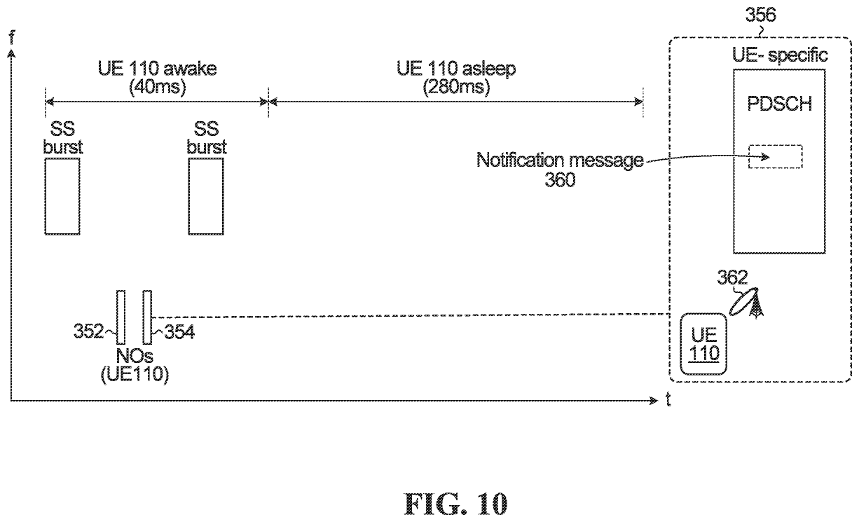

FIG. 10 illustrates a variation of FIG. 7 in which the time-frequency location of the notification message 360 in the data channel (e.g. in the PDSCH in FIG. 10) is configured in advance and so scheduling the notification message 360 is not needed. That is, the UE does not need to monitor the control channel (e.g. the PDCCH) for scheduling and notification indication, and the control channel (e.g. the PDCCH) is omitted. Instead, the UE 110 knows in advance where to find the notification message 360.

In the FIGS. 9 and 10 variations, in some embodiments the time-frequency resources at which a notification message is located may be preconfigured, e.g. in a manner similar to the configuration of grant-free resources. In some embodiments, one or more transmission parameters relating to the notification reception may be preconfigured, such as the modulation and coding scheme (MCS) (e.g., QPSK) and/or the demodulation reference signal (DMRS). The time-frequency resources and/or transmission parameters may be broadcast/groupcast, e.g. in system information (SI), such as in SIB 1. In some embodiments, the notification message size may have a maximum size, and that maximum size may be predefined or broadcast/groupcast, e.g. in SI.

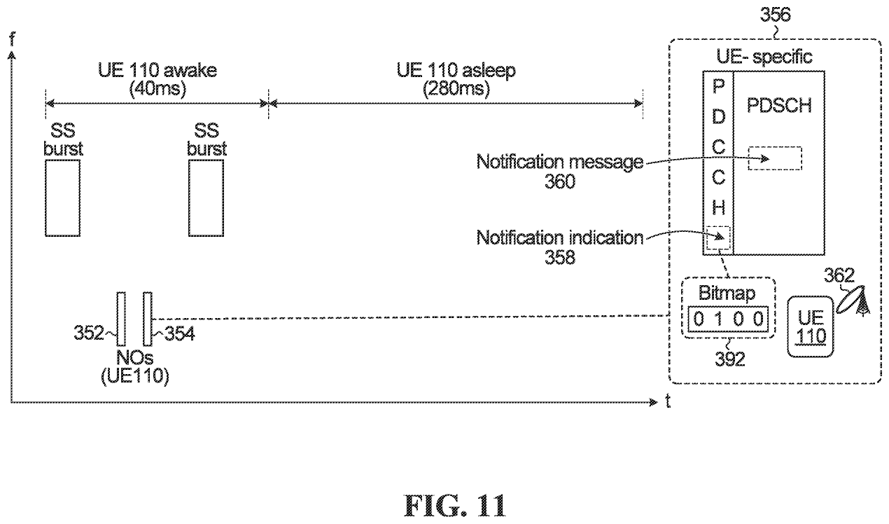

FIG. 11 is an embodiment similar to FIG. 7 in that a notification indication 358 is transmitted in a control channel and the control channel also carries DCI that schedules the notification message 360 in a data channel. The notification indication 358 may have one or more bits to carry more information regarding the notification; for example, a bitmap 392 of any bit size may be used for the notification indication 358. Alternatively, the bitmap 392 may be present in other DCI fields in the control channel. The purpose of the bitmap 392 is as follows. In some embodiments, different types of downlink notifications may be transmitted, e.g. a paging message for UE 110 or a notification of other network control information or an indication that the UE is to switch to a different operating mode or an indication of public or urgent information, etc. In some embodiments, the notification indication 358 (or other DCI fields) includes an indication of the type of notification, with the content of the notification being transmitted in the notification message 360. The indication of the type of notification may be called a “notification cause”. The bitmap 392 indicates the notification cause. For example, the bitmap 392 may be four bits, as illustrated. The bit in position 0 may be reserved. The bit in position 1 may indicate whether or not a notification message 360 is even transmitted in the data channel. If it is transmitted, then the scheduled resources for the notification message 360 may be present in other fields of the DCI in the PDCCH control channel. For example, if the bit in position 1 is set to ‘1’ (as shown in FIG. 11), then this may be an indication that the notification message 360 is transmitted and is for downlink scheduling, e.g. the notification message 360 is a paging message indicating that there is downlink data to be transmitted to UE 110. The notification message 360 may then provide the details, e.g. scheduling information for receiving the downlink transmission, UE-specific uplink synchronization information, etc. If the bit position 1 is set to ‘0’, then a notification message 360 will not be transmitted in the data channel. The bit in position 2 of the bitmap 392 may indicate whether or not the notification is for short message only. If the bit in position 2 were set to ‘1’, then this is an indication that the UE specific notification message 360 is not to be transmitted, but a short and public message is to be transmitted to the UE 110 via common control channel (e.g., broadcast/groupcast channel), such as a disaster warning; alternatively, the notification message 360 may be transmitted in the data channel with the short message included in the notification message 360, in which case the notification message 360 might or might not be UE-specific. If the bit in position 3 were set to ‘1’, then this is an indication that there is both a UE-specific notification message 360 and a short and public message, where the short and public message might or might not be included in the notification message 360. In some embodiments, if the bit in position 0 were set to ‘1’, the notification indication indicates an instruction for the UE 110 to modify its operating mode (e.g. an indication to switch to a different mode of operation, such as a mode that consumes more power but that has increased UE capabilities). Note that the above is only functional description of bit usage, and the above described bit in terms of its functionality can be located in any position in a bit map without necessarily the ordering as described.

In some embodiments, rather than in DCI (e.g. rather than in the notification indication 358 or other DCI in the control channel), the bitmap 392 may instead be present in system information (SI). In some embodiments, the bitmap 392 is instead present in the data channel, e.g. as part of the notification message 360. In some embodiments, the bitmap 392 may be predefined or configured in higher layer signaling, such as RRC signaling, e.g. the length of the bitmap and/or what each bit indicates in the bitmap 392 may be configured. Either of the variations illustrated in FIGS. 9 and 10 may be incorporated into the embodiment illustrated in FIG. 11.

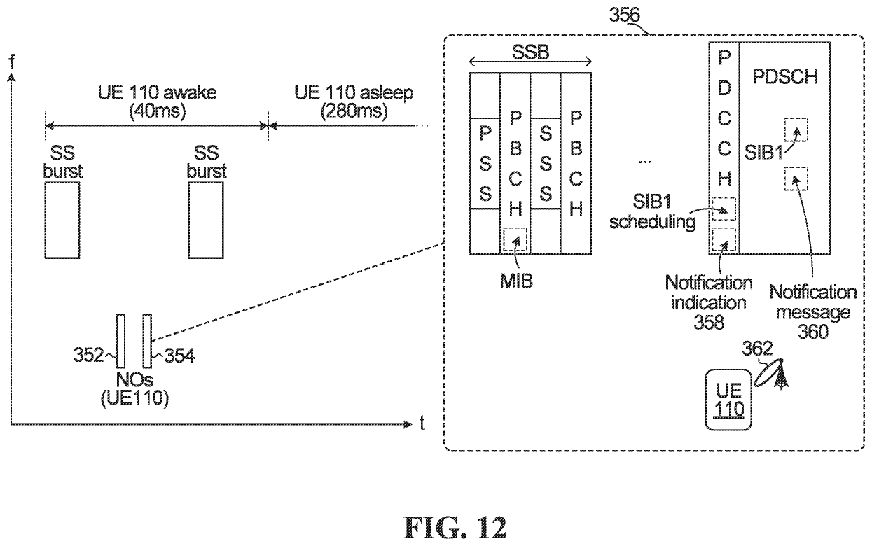

FIG. 12 illustrates an alternative embodiment in which a UE-specific downlink beam sent during a NO also includes synchronization information, such as a SSB (as illustrated) to allow for the UE 110 to both synchronize with the network in the downlink and obtain the downlink notification. In the embodiment illustrated in FIG. 12, the UE 110 would not have to use the SS burst to synchronize in the downlink prior to a NO. However, the UE-specific beam is not decoupled from downlink synchronization and/or a SSB. Any of the variations illustrated in FIGS. 9 to 11 may be incorporated into the embodiment illustrated in FIG. 12. More generally, in some embodiments downlink synchronization information and/or system information may be transmitted in a NO, e.g. like in the specific example in FIG. 12. SS bursts might or might not be present, e.g. they may be absent if a different or new downlink synchronization method is being implemented to keep the UE synchronized immediately before the NO. One benefit of including the synchronization information (e.g. the SSB) in a UE-specific beam, like in FIG. 12, is that the UE does not have to search for the strongest beam in a beam sweeping pattern, e.g. using blind detection of SSBs transmitted via the beam sweeping. In some embodiments, the base station may send the uplink synchronization timing info such as timing advancement adjustment instruction to the UE in either a notification indication or UE-specific notification message with the UE-specific beam.

In general, different ways are possible for the UE to downlink synchronize with the network, e.g. using a network pre-defined SI/SSB burst before the notification occasion, like in FIG. 7, or using another synchronization mechanism other than a SI/SSB burst before or at the NO(s) in a DRX cycle, for example, employing CSI-RS-like reference signal(s) specific to the UE or area/region based AI information on synchronization

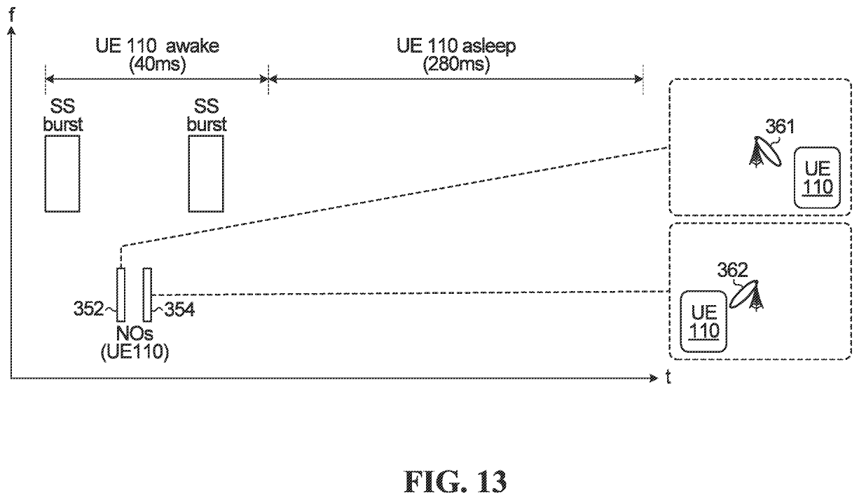

In some embodiments, the UE 110 may move between NOs within a same wakeup duration, in which case the direction of the UE-specific beam may change based on the updated position of the UE 110 at one or more NOs. For example, FIG. 13 illustrates a variation of FIG. 7 in which the UE 110 moves between NO 352 and NO 354. Therefore, the direction of the UE-specific beam is different at each NO 352 and 354 based on the position of the UE 110 during those NOs. For example, a UE-specific beam is transmitted in a first direction 361 during NO 352 and transmitted in a second direction 362 during NO 354.

### Notifications Switching a UE to a Different Operating Mode

As discussed earlier, different types of downlink notifications may be transmitted to a UE in the downlink during a notification opportunity (NO). One type of notification may be a notification instructing the UE to transition from one operating mode to another operating mode. In some embodiments, the switch from one operating mode to another operating mode may be within a single power state, e.g. the UE may transition from a low power mode to a higher power mode within a same power saving state. In other embodiments, switching operating modes may also switch states or vice versa.

A UE has a set of communication parameters used to perform wireless communication. When the UE is transmitting, these communication parameters are sometimes instead called transmission parameters. Examples of communication parameters may include: the number of antennas and/or panels used by the UE, the bandwidth over which the UE communicates, MCS scheme and the decoding method utilized by the UE, etc. Communication parameters may alternatively be called communication settings.

In some wireless communication systems, the UE and network operate according to a radio resource control (RRC) protocol. The RRC protocol has different states. For example, in new radio (NR), the RRC protocol includes: an RRC Idle state in which there is no RRC connection established with the network; a RRC Connected state in which an RRC connection is established; and an RRC Inactive state in which partial RRC resources are reserved thus the RRC functions of the UE may be reduced, e.g. to help save power. In some embodiments, a downlink notification in a NO may explicitly or inherently instruct the UE to move from one RRC state to another RRC state, or from one power saving mode to another power non-saving mode(s) (which might or might not be in a same state)

In some embodiments, within a single state (which might or might not be a single RRC state) there may be different operation modes for a UE that consume different amounts of power, e.g. a default operation mode and an enhanced operation mode. Each operation mode may correspond to a respective power (usage) mode. Example power modes might include sleep, downlink reception only, both downlink reception and uplink transmission, etc. Multiple modes may be within a single state, and/or different states may have different modes. In some cases, transitioning from one mode to another mode might involve changing state. For example, the modes of “sleep” and “downlink reception only” might be two different power modes in a same power-saving state, whereas the mode “both downlink reception and uplink transmission” may be a mode in a non-power-saving state. In some embodiments, after or upon completing initial access to connect to the network, the UE enters a default operation mode that is associated with lower power consumption and power saving state. The UE remains in the default operation mode by default, and only temporarily moves into an enhanced operation mode on demand, e.g. in response to a downlink notification sent in a NO that instructs that UE to move into the enhanced operation mode. Moving into the enhanced operation mode might or might not cause the UE to transition to a new state.

In some embodiments, in the default operation mode the UE utilizes a first set of communication parameters that are associated with a first communication capability, and in the enhanced operation mode the UE instead utilizes a second set of communication parameters that are associated with a second communication capability. The first communication capability consumes less power than the second communication capability.

As a simple example, the first set of communication parameters defining the first communication capability may include: two transmit antennas, one receive antenna, 5 MHz communication bandwidth, monitoring for downlink control information and/or a downlink notification once every 256 frames, one beam for beaming tracking, radio resource management (RRM) measurement performed for only one neighbour cell or no RRM measurement at all, scheduling free (“grant-free”) resources used for transmitting/receiving data, one subcarrier spacing supported, basic HARQ processing time capability (for example 7 OFDM symbols for decoding data and receiving DCI). The second set of communication parameters defining the second communication capability may include: eight transmit antennas, two receive antennas, 100 MHz communication bandwidth, monitoring for downlink control information and/or downlink notification once every two frames, more than one beam for beaming tracking, RRM measurement performed for multiple neighbour cells, additionally or instead transmitting/receiving data on resources scheduled in downlink control information (DCI), two different subcarrier spacings supported, advanced HARQ processing time capability (for example 3.5 OFDM symbols for decoding data and receiving DCI). Operating using the second set of communication parameters consumes more power than operating using the first set of communication parameters, but by operating using the second set of communication parameters the communication capabilities increase. By default, the UE may wirelessly communicate in the default low power operation mode using the first set of communication parameters, with the UE switching to the enhanced power operation mode (that uses the second set of communication parameters) on an on-demand basis in response to a trigger, such as in response to a downlink notification sent in the NO that instructs that UE to move into the enhanced operation mode. In some embodiments, a subsequent notification sent in a subsequent NO instructs the UE to return to the default mode.

In some embodiments, there may be more than two UE operation modes, each associated with a different communication capability and associated UE power consumption. The downlink notification indication or notification message may specifically instruct the UE as to which one of the multiple operation modes the UE is to operate in.

In some embodiments, after or upon completing initial access to connect to the network, the UE enters a default operation mode that is associated with the power saving state based on preconfigured or default parameters for notification, e.g. minimum power and maximum power levels usage based on device type or number of NOs configured based on mobility. The UE remains in the default operation mode by default, and only temporarily moves into an enhanced operation mode on demand, e.g. in response to a downlink notification sent in a NO. In some embodiments, the notification indication or the downlink notification (message) instructs that UE to move into a higher operation mode, where, e.g., both downlink and uplink traffic may be required in operation.

In some embodiments, for a UE in a power saving state, the UE may operate in a default power mode in which a group of basic communication resources and parameters may be configured via one or more of: predefinition, pre-configuration, semi-static configuration, and/or dynamic configuration by way of higher layer signaling and/or layer 1 (physical layer) signaling. The group of basic communication resources and parameters may include one or more of: UE identity, access-source Type (e.g., which 3GPP, non-3GPP, NTN network), dedicated RACH parameters, beamforming info and usage from NW, control information (e.g., power control), timing advance parameter, notification cause type (such as either or both of UE specific notification and common messaging, short message, e.g. emergency info, public heath info, and/or disaster warning, etc.). The UE identity may include one or more notification related IDs, e.g., one ID is used for notification indication; the same or different ID is used for uniquely identifying the UE itself and is associated with cell/network information, and/or the UE authentication/authorization information in the network.

In some embodiments, the UE may maintain downlink synchronization when operating in a higher power mode (e.g. when operating in an enhanced power mode) and might not keep downlink synchronization when operating in a lower power mode (e.g. when operating in a default power mode). In some embodiments, the UE may keep downlink synchronization when operating in a power saving state (e.g. when operating in a default power mode in the power saving state). If the UE is to maintain downlink synchronization with the network, the UE may need to perform synchronization with a network synchronization signal periodically or on-demand; for example, during the channel measurements on one or more cells in configured periods for potential location update over registered tracking area, the downlink synchronization of the UE with the network (e.g., one or more base stations) can be made. If the UE does not maintain downlink synchronization with the network, then the UE synchronizes with the network in the downlink before receiving any downlink information, including the system information (such as MIB and SIB(s)) and the downlink notification. Note that uplink synchronization or timing may require more effort because of interactive message exchanging between the UE and the network, e.g., base station to send a TA adjustment instruction to the UE.

### Configuring the Parameters Relating to Notifications

The number of NOs in a wake-up duration may be configurable, as well as the duration of a NO, and also the notification frame location in the wake-up duration and an offset in the frame for a NO. The configuration may be on a UE-specific basis or by system information such as SIB 1. More generally, many different parameters relating to a downlink notification or NO may be configured or predefined.

In one example, the following parameters are predefined or groupcast/broadcast, e.g., possibly defined in system information, such as in a SIB decoded by the UE upon downlink synchronizing with the network: control channel (e.g. PDCCH) configuration for notification indication; and/or transmission resources used for one or more NOs (e.g. time and/or frequency and/or modulation and coding scheme (MCS) and/or demodulation reference signal (DRMS) and/or numerology and/or transmission bandwidth and/or carrier frequency band used for one or more NOs); and/or notification and DRX parameters, such as time offset, duration, periodicity/cycle.

In some embodiments, a notification flag (possibly in system information) may indicate to a UE whether or not there is a coming notification in one or more DRX cycles or one or more notification opportunities. If the flag indicates no coming notification, then the UE does not need to check for a notification during a NO and the UE will therefore consume less power, and possibly the UE can stay in a same power mode, depending upon the implementation or configuration.

In one example, the following parameters can be configured semi-statically, e.g. by RRC signaling, either unicast or group-cast: notification ID for notification indication reception; and/or UE ID for notification message reception; and/or transmission resources used for one or more NOs (e.g. time and/or frequency and/or MCS and/or DRMS and/or antenna ports/beamforming parameters and/or numerology and/or transmission bandwidth and/or carrier frequency band and/or process ID used for one or more NOs); and/or notification parameters such as notification frames, time offset, NO duration, periodicity/cycle, # of notification occasions in each DRX cycle, redundant transmission version of each notification occasion, etc.; and/or notification message and format configuration; and/or quasi-colocation (similar channel condition) configuration in terms of Doppler Shift, Doppler Spread, Average Delay, Delay Spread, Spatial Receive Parameter, e.g. indicating a PDCCH is quasi-co-located with a SSB.

In another example, the following parameters may be configured dynamically or by physical layer signaling (e.g. in downlink control information (DCI)), or via a combination of semi-static and dynamic configuration: transmission resources used for one or more NOs (e.g. time and/or frequency and/or MCS and/or DRMS and/or antenna ports/beamforming parameters and/or numerology and/or transmission bandwidth and/or carrier frequency band and/or process ID used for one or more NOs); and/or notification parameters such as notification frames, time offset, NO duration, redundant transmission version indication; and/or quasi-colocation (similar channel condition) configuration in terms of Doppler Shift, Doppler Spread, Average Delay, Delay Spread, Spatial Receive Parameter, e.g. indicating a PDCCH is quasi-co-located with a SSB.

In some embodiments, the notification frame and/or slot and/or optionally the first control channel (e.g. PDCCH) monitoring location may be predefined (e.g. fixed) or configured (e.g. in system information (SI)). In some embodiments, the NO configuration may be defined in terms of time offset (e.g. offset in time in relation to the start of a frame) and/or duration of NO.

In some embodiments, the periodicity of the wakeup may be configured (e.g. a repeating pattern of 40 ms awake followed by 280 ms asleep may be configured). In some embodiments, a plurality of different wakeup/sleep cycle durations may be predefined (e.g. fixed), with one of those different wakeup/sleep cycle durations being selected on a semi-static or dynamic basis. For example, the following cycle durations may be predefined: 320 ms (including 40 ms awake followed by 280 ms asleep), 640 ms (including 80 ms awake followed by 560 ms asleep), 1280 ms (including 160 ms awake followed by 1120 ms asleep), 2560 ms (including 320 ms awake followed by 2240 ms asleep). One of the preceding four predefined cycle durations may then be selected and indicated to one or more UEs, e.g. on a semi-static or dynamic basis.

Indicating when there is No Downlink Notification

Even though there may be one or more NOs configured for a UE in one or more wake-up durations, there may not always be a downlink notification for that UE. In some embodiments, the UE may still listen during each NO for a possible downlink notification. For example, in the embodiment described in relation to FIG. 7, UE 110 may check for a notification indication 358 in each of NOs 352 and 354, regardless of whether the base station 170 has a downlink notification to send to the UE 110. However, listening for a downlink notification when one is not present may be a waste of power resources for UE 110.

Therefore, in some embodiments, methods may be implemented to indicate, to a UE, that there is no downlink notification for the UE during a particular period of time, e.g. for a particular wakeup duration. This may allow for the UE to conserve power, e.g. to stay in a low power mode rather than continue in the wakeup duration to consume more power, or stay in a power saving state without further action, etc.

In some embodiments, system information (SI) is used to indicate to one or more UEs whether there is a downlink notification for that UE. For example, in the embodiment of FIG. 7, at the start of a wakeup duration UE 110 may first synchronize with the network using a beam of an SS burst and obtain SI, such as the MIB or a SIB (e.g. SIB 1). As part of the SI (e.g. in SIB 1 or in the MIB), the network may indicate whether or not there is a downlink notification for the UE 110 during that wakeup duration. If there is a downlink notification, then the UE 110 listens for a notification during NOs 352 and 354. If there is not a downlink notification, then the UE 110 re-enters the sleep mode early and/or does not listen for a notification during NOs 352 and 354. In some embodiments, the indication may be transmitted in a medium access control (MAC) control element (CE). In some embodiments, for a group of UEs the network may broadcast (e.g. in SI) which UEs have outstanding downlink notification messages. Only those UEs that have outstanding downlink notification messages listen during their NOs.

In some embodiments, if there is no downlink notification for a UE, then a message is transmitted to the UE indicating that there is no downlink notification. The message may be transmitted in the first NO in the UE's wakeup duration. For example, the message may be transmitted in NO 352 for UE 110 in FIG. 7. The message may alternatively be transmitted somewhere else, e.g. near the start of the wakeup period. In some embodiments, if the UE receives such a message, then in response the UE re-enters the sleep or low power mode, even if the wakeup duration is not complete, or the UE performs some other action such as remaining in a low power mode. In some embodiments, instead of a message, a special sequence may be transmitted, e.g. if a particular sequence is transmitted in a UE-specific beam during the wakeup duration then it means that there is no downlink notification for the UE. The sequence may be a predefined pilot and/or a Zadoff-Chu (ZC) sequence and/or any configured or predefined randomized sequence for single detection and decoding, etc.

In some embodiments, a groupcast/broadcast message or sequence may be transmitted to a group of UEs indicating to those UEs that there is no downlink notification for those UEs. The message or sequence may instead be sent when there is a downlink notification for one, some, or all UE in a group of UEs. In either case, the groupcast/broadcast message or sequence may pertain to a particular duration of time, e.g. a common DRX cycle or wakeup duration. In some embodiments, the message or sequence is transmitted in a common control channel, e.g. as part of SI.

In some embodiments, a MIB and/or a SIB (e.g. SIB 1) includes an indication of whether or not there is a downlink notification for each of one or more UEs. In some embodiments, the indication may be in an information element (IE), e.g. in a MIB IE. In some embodiments, a field in a physical broadcast channel (PBCH) (e.g. in a SSB) may contain the indication that indicates whether or not there is a downlink notification for each of one or more UEs. In some embodiments, the presence of a particular demodulation reference signal (DMRS), e.g. in a PBCH in a SSB, may indicate that there is not a downlink notification for each of one or more UEs. The indication may be conveyed based on the location of the DMRS (e.g. the DMRS at a particular time-frequency location or changed time-frequency location) and/or sequence of the DMRS. Regardless of the way the indication is provided to the UE(s), the indication might only apply to a particular paging occasion or DRX cycle or wakeup duration.

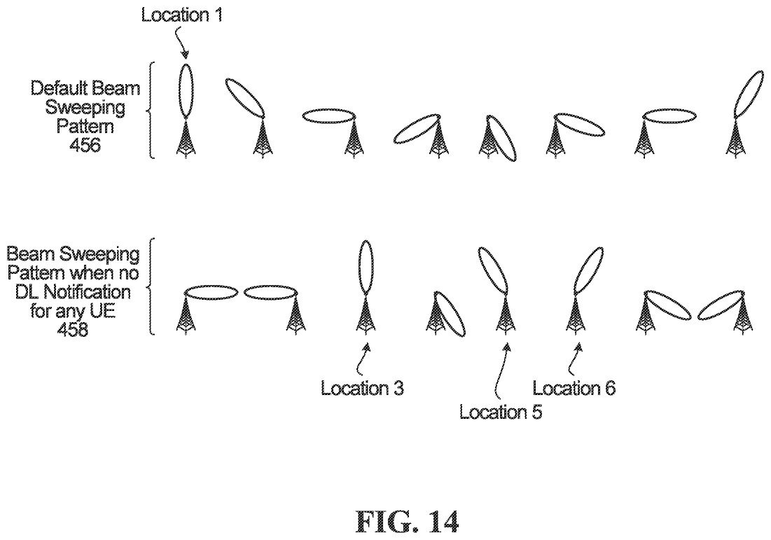

In some embodiments, beam sweeping of a certain pattern indicates to one or more UEs that there is no downlink notification for those one or more UEs. The direction of each beam in a beam sweeping pattern might or might not be transparent to the UE (e.g. depending upon whether the UE implements receive beamforming). However, if the beam sweeping pattern changes than it may be an indication that there is no downlink notification for one or more UEs. A UE may detect a change in pattern by detecting that the downlink beam having the strongest signal is at a new location in the pattern. For example, FIG. 14 illustrates two beam sweeping patterns 456 and 458 transmitted for the purposes of downlink synchronization and transmission of system information. Beam sweeping pattern 456 is the default beam sweeping pattern. Beam sweeping pattern 458 is instead implemented by the base station 170 when, during a particular predefined/preconfigured period of time, there is no downlink notification for any UE. In some embodiments, a UE may determine a change in beam sweeping pattern made by the network by determining a change of the location in the pattern of the strongest beam for that UE. For example, the strongest beam direction for UE 110 may be at location 1 in default beam sweeping pattern 456, but the strongest beam direction for UE 110 may instead be at location 3 in beam sweeping pattern 458. In some embodiments, the UE may determine a change in beam sweeping pattern by determining a change in the sequence of different strength measurements of beams in the beam sweeping pattern. For example, in the default beam sweeping pattern 456 the beam at location 1 is the strongest for UE 110, with the adjacent neighbouring beam on each side being second strongest, whereas in beam sweeping pattern 458 the beam at location 3 is the strongest, with the beams at location 5 and 6 being the second strongest. A benefit of using the beam sweeping pattern to indicate whether or not there is a downlink notification is that a UE may not even need to synchronize to the network if the beam sweeping pattern indicates that there is no downlink notification for the UE. In some embodiments, a plurality of beam sweeping patterns may be utilized, each one having a mapping to respective different information (e.g. each one providing a different indication)

Other new operational information may also or instead be included in the system information (e.g. in an MIB IE) and/or indicated by way of the DMRS and/or indicated by way of the beam sweeping pattern. Examples of such operation information may include network identity info and/or a new system frame number option and/or sub-frame option, etc.

In some embodiments, the methods of indicating that there is no downlink notification operate independently of UE-specific notifications. For example, the methods described above (e.g. incorporating the indication into SI or a unique sequence, or indicating via a change in beam sweeping pattern) may be incorporated into a group paging method such as that described in relation to FIG. 6.

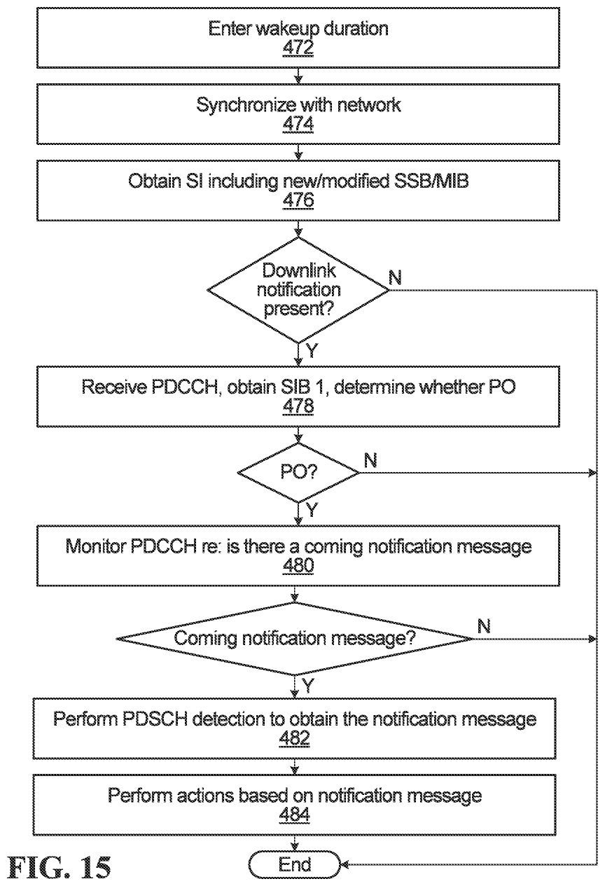

FIG. 15 illustrates a method performed by UE 110, according to one embodiment. At step 472, the UE 110 enters a wakeup duration (e.g. a DRX “onDuration”). At step 474, the UE 110 uses a SSB in the strongest beam of a beam sweeping pattern to synchronize with the network and perform physical cell identification. At step 476, the UE obtains system information (SI) that is either broadcast or unicast to UE 110. The SI includes a new or modified SSB field (e.g. a new or modified MIB) that indicates whether or not there is a downlink notification (e.g. a paging message) for the UE 110. The new or modified SSB field may indicate whether or not there is a downlink notification for multiple UEs. If the new or modified SSB field indicates that there is no downlink notification for UE 110, then the method ends, e.g. the UE 110 re-enters sleep mode. Otherwise, if there is a downlink notification for UE 110 then the method proceeds to step 478. At step 478, the UE 110 performs reception of a PDCCH (e.g. on the same beam in the beam sweeping pattern, but at a later time, such as in a later time slot corresponding to that beam in the pattern), obtains the SIB 1, and determines whether it is a paging occasion (PO). If it is not a PO, then the method ends, e.g. the UE 110 re-enters sleep mode. Otherwise, if it is a PO, then the method proceeds to step 480. At step 480, the UE monitors the PDCCH to check whether there is any coming notification message (e.g. paging message). The notification message may be a group paging message, e.g. like in FIG. 6. If there is not a coming notification message, then the method ends, e.g. the UE 110 re-enters a sleep mode. Otherwise, if there is a coming notification message, then the method proceeds to step 482. At step 482, the UE 110 performs PDSCH detection to check for and obtain the notification message (e.g. the group paging message). At step 484, the UE performs actions based on the notification message.

In a variation of FIG. 15, at step 478 the SIB 1 may instead or additionally include an indication of whether there is a downlink notification for UE 110. If there is not a downlink notification for UE 110, then the method may end at step 478, e.g. the UE 110 re-enters sleep mode or low power mode (in the power saving state). In a variation of FIG. 15, a PO is assumed if the new/modified field in the system information indicates that a downlink notification is present. In a variation of FIG. 15, it is assumed that there is a coming notification message if the new/modified field in the system information indicates that a downlink notification is present.

In view of and in addition to the above, methods for indicating that there is no downlink notification for a UE, e.g. within an upcoming NO or DRX cycle, may include:
A UE-specific indication of no downlink notification, e.g. sending a special paging message using the UE-specific notification indication or notification message, e.g., in a MAC CE, some special value, or notification cause of “stop”.
Transmitting a special sequence in UE-specific beamforming, e.g. a predefined pilot, ZC sequence, any randomized sequence for single detection and decoding, etc.
Transmitting an indication to a group of UEs. The indication may be transmitted to a group of UEs for which there is no notification message(s) in a common period, such as in an upcoming one or more DRX cycles.
A group-cast/broadcast message can be used, e.g., in a common control channel such as SI/SSB, e.g., MIB and/or SIB(s).

### Other Variations

In some embodiments above, e.g. FIG. 7, the notification indication 358 is transmitted in a control channel on a UE-specific beam during a NO. In alternative embodiments, the notification indication 358 may be transmitted somewhere else, e.g. in system information (SI), such as in a SIB, which may be transmitted on the beams of the beam sweeping pattern and accessed when the UE 110 is performing synchronization prior to the NO.

In some embodiments, the numerology (e.g. subcarrier spacing (SCS)) used to receive the notification indication 358 and/or the notification message 360 may be the same as the numerology used to receive the system information (SI), or possibly different from the numerology used to receive the SI but predefined.

In some embodiments, a UE might or might not be required to soft combine multiple notification indications 358 and/or multiple notification messages 360 within one or multiple NOs. Soft combing may be implemented if the multiple notification indications 358 or multiple notification messages 360 are the same.

In some embodiments, quasi-co-location (QCL) between two or more channels may be configured or indicated to the UE such that one channel condition or transmission assumption is similar to another QCLed-channel condition or transmission assumption, which may assist the UE in decoding/reception. For example, QCL may be configured or indicated between SSBs and/or between notification indications sent in a control channel (such as in DCI) and/or between notification messages. In some embodiments, QCL may be configured and leveraged in UE-specific beamforming (like in FIG. 7) or even beam sweeping based notification (like in FIG. 6). If the QCL assumptions are made and leveraged in beam sweeping based notification, then the notification indication and messages may be multiplexed in (or in association with) SSBs.

In some embodiments, the monitoring window for system information (SI) may be configured, e.g., the time offset (e.g. in relation to the start of a frame) and/or the duration of the SI and/or the periodicity of the SI may be configured.

In many embodiments above, beamforming is discussed as being performed by the base station when transmitting a downlink beam to a UE, e.g. when transmitting a UE-specific beam to a UE that carries a UE-specific notification. A UE might or might not also implement a receive beam to receive a downlink beam from the base station. For example, the UE may implement a corresponding receive beam if the UE has knowledge of its orientation in relation to the base station. A receive beam may be implemented by performing signal processing on the received signal in a way that causes the received signal to experience constructive interference in a particular direction. The particular direction is based on the UE's orientation knowledge relative to the base station and in general would correspond to the same angle/direction as the transmit beam from the base station. Multiple receive beams may be implemented by the UE in some embodiments. As mentioned earlier, a UE may operate in different power modes, e.g. a default low power mode and an enhanced power mode. In some embodiments, in a lower power mode (e.g. a default low power mode) the UE might not implement beamforming/multiple beams for transmission and reception, and the UE might not have orientation or beamforming direction knowledge of the base station. In some embodiments, the downlink notification may instruct the UE to enter into a higher power mode in which the UE implements beamforming, in which case the base station may transmit the orientation or beamforming direction knowledge to the UE, e.g. as part of the downlink notification message.

In some embodiments, error handling is performed by the base station and/or by a UE if an abnormal or unexpected event occurs. An example of an abnormal or unexpected event is that a downlink notification sent by the base station in a UE-specific beam is not received by the UE. As an example, the base station may believe that the UE is in a particular position different from the actual position of the UE, e.g. if the UE is fast moving and/or if there is an error in relation to determining the position of the UE. The base station may therefore transmit the UE-specific notification in a beam that is not in the direction of the UE, such that the UE is unable to decode the notification because the signal in the actual direction of the UE is too weak. In some embodiments, the network may determine that the UE did not receive the notification when a particular action is not performed by the UE, e.g. the UE does not reply to the notification (if a reply is expected), or the UE fails to perform an expected action (e.g. the notification is a paging message for the UE and the UE does not acknowledge subsequent receipt of the downlink data). In some embodiments, a notification timer or counter may be used at the base station and/or the UE to trigger the error handling, e.g. if transmission of the notification is not successful after a particular threshold number of NOs and/or after a particular threshold amount of time (e.g. upon expiry of a timer), then error handling occurs. Therefore, events that trigger error handling may possibly include: a notification message for the UE has been transmitted to the UE the (configurable) maximum number of times and/or beyond a (configurable) timer period; and/or an intentional action from the UE as a consequence of the notification is not taken. Possible reasons why a UE might not receive a downlink notification may include inaccurate beamforming information, poor channel conditions, and/or interference in the cells. Error handling may be implemented in different ways. In one example, the UE and base station may revert to a method like in FIG. 6 in which the UE can find the strongest beam in the beam sweeping pattern associated with a SS burst and then obtain a notification message on the beam of that pattern, e.g. FIG. 6 modified such that the notification indication 358 is transmitted in the PDCCH in FIG. 6 and the notification message 360 is transmitted in the PDSCH in FIG. 6. In some embodiments, error handling may involve increasing the number and/or power strength of beams (e.g. UE-specific beams), and/or implementing some known and conservative beam patterns (e.g., SSB patterns) to send the notification message or notification indication to the UE, where either unicast or group-cast may be used. In one embodiment, a UE with failed UE-specific notification receptions that are expected may start again following the procedure of initial network entry, once, for example, a configured timer expires or when the predefined condition for the notification error occurring is met. In some embodiments, the base station may provide a missing indication in the notification message. In some embodiments, the base station may stop the transmission of the notification message to the UE for a configurable period of time. These configurations may be predefined or pre-configured, e.g. semi-statically configured or dynamically configured by the network. In some embodiments, during error handling the UE has configured one or more special channels and/or beams such as network SI/SSB patterns or special beams for conservative notification reception, with the corresponding actions taken at the network/base station side.

In some embodiments, two UEs that happen to be in the same beam direction may be assigned respective time-frequency resources in a same beam, where the time-frequency resources are orthogonal or use different demodulation reference signals to distinguish the resources for carrying the UE-specific notification for one UE from the UE-specific notification for the other UE. In some embodiments, non-orthogonal multiple access (NOMA) may be used to distinguish the UE-specific notification for one UE from the UE-specific notification for the other UE. In some embodiments, a notification message may be for more than one UE, e.g. if those UEs are located in the same beam orientation (e.g. if the UEs are static and in the same location).

In some embodiments, if two or more UEs are at a very close or same location (e.g. co-allocated in the same beam orientation) at same NO(s) in a DRX cycle, then their beamforming from the base station may be very close or the same. In this case, multiple UE MIMO may be applied to transmit the individual UE-specific notification messages, or orthogonal frequency resources can be assigned to the two or more UEs. Because the UEs may move around, the NO time resource configuration and/or frequency resource configuration may need to be updated in some scenarios, e.g. where a reconfiguration is needed to be performed and/or an indication is needed to be transmitted by the network to update the NO resource(s). For example, an indication may be transmitted in the downlink to switch a UE BWP from one to another when more than one BWP is configured for the UE. In some embodiments, UEs in a same beam direction may be configured with orthogonal DRMSs but same NO resources, and their signals may be separated by a NOMA scheme at the UEs. In some embodiments, the multiple notification messages for different UEs whose beamforming turns out to be same may be combined into a single notification message at network, which is then transmitted with beamforming, e.g. in a single PDSCH channel while the notification indication is transmitted in the DCI. The DCI may include UE-specific notification indications, each for one UE, or a single indication to the notification message for the multiple UEs (e.g., a group ID may be used for multiple UEs to mask the CRC of the single indication).

In some embodiments, if a UE is near a cell edge then multiple UE-specific beams may be transmitted to the UE in a NO, each one from a respective different base station.

In some embodiments, UE-specific beamforming may be configured to be the same as one of the SSB beam patterns in terms of, e.g., antenna port and/or DMRS parameters, e.g. for UEs with low cost and/or slow mobility within the SSB coverage.

In some embodiments, the time domain resource may be configured for a NO, but the frequency resource of the NO may be the same frequency as an SSB.

In some embodiments, a notification message may be transmitted via a broadcast system information (SI) message in SI/SSB burst, especially when the message is the same and common to every UE in the network, such as a public health or criminal warning message.

In some embodiments, a first UE may be out of coverage of a base station, in which case a second UE in coverage of the base station may be able to receive the notification for the first UE and forward the notification to the first UE via a sidelink channel, e.g. using device-to-device (D2D) communication. The downlink beam from the base station would be specific to the second UE, e.g. pointed in the direction of the second UE with the time-frequency resources carrying the notification being dedicated to the second UE in that beam. However, the notification itself would be for the first UE. In some embodiments, the second UE is a master UE in a D2D group. In some embodiments, the first UE is a slave UE in the D2D group. In some embodiments, the connection between the first UE and the second UE may be Wi-Fi or Bluetooth. In some embodiments, the first UE is not out of coverage of the base station, but may be in a very low power mode such that the first UE cannot receive downlink transmissions from the base station but can only receive sidelink D2D communications from the second UE.

In some embodiments, the second UE is not necessarily a master UE, but is the UE responsible for monitoring the downlink notifications for one, some or all of the UEs in the D2D group. When a downlink notification is to be sent to one of the UEs in the D2D group, the base station transmits the downlink notification to the second UE in a UE-specific beam for that second UE, and then the second UE forwards the downlink notification using D2D communication. In some embodiments, the UE responsible for receiving and forwarding the downlink notification (e.g. the “second UE” in the explanation above) changes over time. For example, the responsibility for receiving and forwarding downlink notifications rotates between some or all of the UEs in the D2D group, e.g. in a round-robin fashion. In some embodiments, the UE responsible for receiving and forwarding the downlink notification does not necessarily have to receive the downlink notification in a UE-specific beam. For example, an embodiment such as that in FIG. 6 may be implemented in which a group paging message is sent in each beam of a beam sweeping pattern, and only one UE in a D2D group might be responsible for obtaining the group paging message and then notifying, via D2D communication, any UEs in the D2D group for which there is a downlink notification.

### Further Methods

In view of and in addition to the above, various methods are provided below.

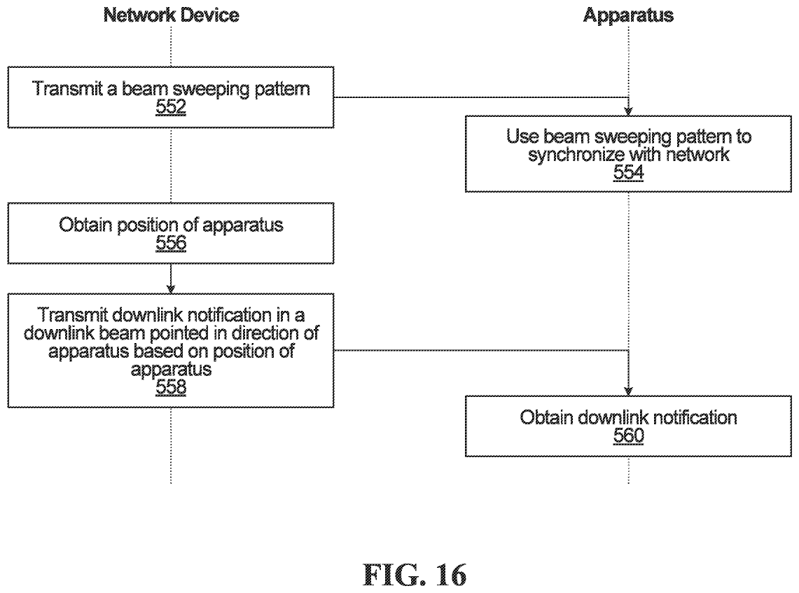

FIG. 16 illustrates a method performed by an apparatus (e.g. UE 110) and a network device (e.g. a base station 170), according to one embodiment.

At step 552, the network device transmits a beam sweeping pattern including synchronization information. For example, the synchronization information may be or include a SSB. In some embodiments, the synchronization information might or might not be transmitted in a SSB. In some embodiments, the synchronization information may be a PSS and/or a SSS. In some embodiments, the beam sweeping pattern may also be used to transmit system information, e.g. a MIB and/or a SIB (such as SIB 1), etc.

At step 554, the apparatus uses a beam in the beam sweeping pattern to synchronize with the network. In some embodiments, synchronization may include detecting a sequence (such as a PSS and/or SSS) to determine timing, e.g. downlink timing, such as the timing of a SSB. In some embodiments, system information is also decoded.

Steps 552 and 554 are optional if the method begins after the apparatus has synchronized with the network.

At step 556, the network device obtains the position of the apparatus in the network. For example, the position of the apparatus may be obtained using any of the methods described earlier, e.g. positioning sensing by the network device. In some embodiments, obtaining the position of the apparatus may comprise simply retrieving, from memory, an indication of the position of the apparatus, e.g. if the position of the apparatus is previously determined prior to the method of FIG. 16.

At step 558, during a notification opportunity, the network device transmits a downlink notification for the apparatus at a time-frequency resource in a downlink beam pointed in the direction of the apparatus. The direction of the downlink beam is based on the position of the apparatus.

At step 560, the apparatus obtains the downlink notification for the apparatus at the time-frequency resource in the downlink beam, e.g. by decoding the downlink notification. In some embodiments, the downlink notification may be transmitted in a data channel (e.g. like in FIGS. 7 and 10), whereas in other embodiments the downlink notification may be transmitted in a control channel (e.g. like in FIG. 9). In some embodiments, the control channel may have notification scheduling information that indicates the time-frequency resource in the downlink beam (in a data channel) at which the downlink notification is located (e.g. like in FIG. 7).

In some embodiments, the time-frequency resource in the downlink beam is dedicated to the apparatus. Additionally, or alternatively, in some embodiments, the downlink notification includes information specific to the apparatus, i.e. information only meant for the apparatus. In some embodiments, the downlink notification includes downlink beam information. The downlink beam information may be for, e.g., possible beam updating, switching, beam fine-tuning, intra-network switching, inter-network switching between networks such as TN and NTN, etc.

In some embodiments, the downlink notification includes at least one of: (1) a paging message indicating that there is downlink data to transmit to the apparatus; (2) control information for the apparatus; (3) an indication that the apparatus is to switch to a different operating mode (e.g. a different mode having different apparatus communication capabilities, but also different associated power consumption).

In some embodiments, like as illustrated and described in relation to FIG. 16, the downlink beam is not part of a downlink beam sweeping pattern, and prior to receiving the downlink beam the apparatus synchronizes with the network using at least one synchronization signal in a beam of the downlink beam sweeping pattern. For example, the network device may transmit a plurality of beams of the downlink beam sweeping pattern, each beam of the plurality of beams carrying synchronization information for the apparatus to synchronize with the network. In some embodiments, system information (e.g. MIB, SIB, such as SIB 1) is also obtained from the beam of the beam sweeping pattern. For example, each beam of the plurality of beams may carry system information (and possibly the same system information). In some embodiments, the system information includes an indication of whether or not there is the downlink notification for the apparatus.

In some embodiments, the time-frequency location of the notification opportunity may be configured, e.g. by the apparatus receiving signaling indicating the downlink time-frequency location of the notification opportunity. In some embodiments, the signaling is included as part of the system information.

In some embodiments, the apparatus is one of a plurality of apparatuses in the network, and the method includes obtaining a respective position of each apparatus of the plurality of apparatuses in the network. In some embodiments, for each apparatus of the plurality of apparatuses in the network, the method may include: transmitting a respective downlink notification for that apparatus in a respective downlink beam pointed in the direction of that apparatus. The direction of the respective downlink beam may be based on the respective position of the apparatus. In some embodiments, the respective downlink beam for each apparatus of the plurality of apparatuses is in a different direction.

FIG. 16 illustrates steps of both the network device and the apparatus. From the perspective of the apparatus, the method might only include steps such as receiving a notification during a notification opportunity at a time-frequency resource, and decoding information carried by the notification.

In some embodiments, the notification is apparatus-specific, e.g. the notification is for the single apparatus and not for a group of apparatuses. The time-frequency resource at which the notification is received is dedicated to the apparatus.

In some embodiments, the notification is received when the apparatus is in a power saving state. In some embodiments, the power saving state is a state in which the apparatus does not monitor DCI until it enters a wake-up duration. An example of a wake-up duration is a DRX on duration. In some embodiments, the power saving state is a state in which the apparatus occupies fewer resources available for downlink and/or uplink transmission compared to a non-power saving state, and/or the UE utilizes fewer transmission parameters compared to a non-power saving state. As a result, the UE consumes less power than when in a non-power saving state. The power saving state may include more than one power mode to operate at different levels of functionality within the power saving state.

In some embodiments, the information carried by the notification includes downlink beam information. In some embodiments, the downlink beam information may be used for any one, some, or all of the following:
Transceiver beamforming by the apparatus. For example, the apparatus uses the downlink beam information to perform receive beamforming, e.g. to generate a receive beam that corresponds to the transmit beam direction, e.g. to try to achieve beam correspondence.
Updating the beam tracking of the apparatus.
Using the beam information for measurement and potential beam switching.
Inputting the beam information for apparatus training or sensing, e.g. to fine-tune the beam information.

In some embodiments, the downlink beam information may be implicit, e.g. the apparatus may measure the notification beam signal (e.g., the beam angular information (BAI)), and by doing so the apparatus may obtain information of the downlink beam direction or other transmitter beam direction (such as drone, satellite station), which may be used for apparatus beamforming to perform later transmissions or receptions.

In some embodiments, the apparatus might not perform receive beamforming initially, e.g. the apparatus uses a wide beam to receive the notification. The apparatus may subsequently perform receive beamforming, e.g. using the downlink beam information received in the notification. In some embodiments, receive beamforming is determined based on the apparatus's previous knowledge, e.g. from previous apparatus-side sensing. In this case, receive beamforming may be implemented to receive the notification.

In some embodiments, the downlink beam information comprises a downlink beam direction or subspace. A subspace may be a set of spatial parameters to describe the beam/antenna orientation and direction.

In some embodiments, the notification is received in a downlink beam pointed in a direction of the apparatus, as is the case in FIG. 16. However, more generally this is not necessary. For example, the notification may be received in a wide beam, omnidirectional beam, or a beam that is not necessarily pointed in the direction of the apparatus. If the notification is received in a downlink beam pointed in a direction of the apparatus, then the direction of the apparatus may be based on a position of the apparatus (e.g. as per step 556 of FIG. 16).

In some embodiments, the notification includes information specific to the apparatus. The information specific to the apparatus may include at least one of the following: a paging message indicating that there is downlink data to transmit to the apparatus; short traffic; control information for the apparatus to trigger an action. An example of short traffic is a short message, e.g. a short message for public warning. Examples of actions that may be triggered include: switching to a different operating mode, and/or performing channel state measurement and reporting, and/or performing full connection setup with the network.

In some embodiments, a downlink beam in which the notification is received is not part of a downlink beam sweeping pattern (as is the case in FIG. 16), and prior to receiving the notification the apparatus may synchronize with a network using at least one synchronization signal in a beam of the downlink beam sweeping pattern. In some embodiments, the apparatus may obtain system information from the beam of the beam sweeping pattern. In some embodiments, the system information may include at least one of the following: an indication of whether there is the notification for the apparatus; configuration information for the notification opportunity. The configuration information for the notification opportunity may include, for example, the notification periodicity and/or how many notification opportunities per period.

In some embodiments, prior to receiving the notification the apparatus may receive control signaling. The control signaling may include at least one of the following: an indication of whether there is the notification for the apparatus; an indication that the apparatus is to switch to a different operating mode; a common short message from a network. The control signaling may be layer 1 (e.g. DCI) signaling. Alternatively, the control signaling may be higher layer signaling. The control signaling may configure the time-frequency resource and/or other relevant transmission parameters for the notification.

From the perspective of the network device, the method might only include steps such as during a notification opportunity, transmitting a notification for the apparatus at a time-frequency resource. In some embodiments, the network device obtains the position of the apparatus, and the notification is transmitted in a downlink beam pointed in a direction that is based on the position of the apparatus. In some embodiments, the notification is apparatus-specific. In some embodiments, the notification includes downlink beam information. In some embodiments, the downlink beam information comprises a downlink beam direction or subspace.

In some embodiments, the notification includes information specific to the apparatus. In some embodiments, the information specific to the apparatus includes at least one of the following: a paging message indicating that there is downlink data to transmit to the apparatus; short traffic; control information for the apparatus to trigger an action.

In some embodiments, the downlink beam is not part of a downlink beam sweeping pattern, and prior to transmitting the downlink beam the network device transmits a plurality of beams of the downlink beam sweeping pattern, each beam of the plurality of beams carrying synchronization information for the apparatus to synchronize with the network. In some embodiments, each beam of the plurality of beams carries system information. In some embodiments, the system information includes at least one of the following: an indication of whether there is the notification for the apparatus; configuration information for the notification opportunity.

In some embodiments, prior to transmitting the notification the network device may transmit control signaling. The control signaling may include at least one of the following: an indication of whether there is the notification for the apparatus; an indication that the apparatus is to switch to a different operating mode; a common short message from a network.

In some embodiments, the apparatus is one of a plurality of apparatuses, and the network device performs operations possibly including: obtaining a respective position of each apparatus of the plurality of apparatuses; and for each apparatus of the plurality of apparatuses: transmitting a respective notification for that apparatus in a respective downlink beam pointed in the direction of that apparatus. The direction of the respective downlink beam may be based on the respective position of the apparatus. The respective downlink beam for each apparatus of the plurality of apparatuses may be in a different direction.

An apparatus is also configured to perform any of the apparatus steps above. For example, the apparatus may include a processor and a memory. The memory may include processor-executable instruction that, when executed by the processor, cause the processor to control the apparatus to perform the methods. In some embodiments, the apparatus may include a memory, e.g. to store an indication of a time-frequency location of a notification opportunity. In some embodiments, the processor directly performs or instructs the apparatus to perform the method steps performed by the apparatus. For example, the processor may instruct the apparatus to receive a downlink beam by instructing the receive circuitry of a receiver to perform reception. As another example, the processor may obtain the downlink notification by decoding that received at the time-frequency location at which the downlink notification was expected to be transmitted.

A network device is also configured to perform any of the network device steps above. For example, the network device may include a processor and a memory. The memory may include processor-executable instruction that, when executed by the processor, cause the processor to control the network device to perform the methods. In some embodiments, the network device may include a memory, e.g. to store an indication of a position of an apparatus. In some embodiments, the processor directly performs or instructs the network device to perform the method steps performed by the network device. For example, the processor may instruct the network device to transmit a downlink beam by instructing the transmit circuitry of a transmitter to perform the transmission, e.g. using the beamforming implemented by the processor to cause the beam to be pointed in the direction of the apparatus. As another example, the processor may obtain the position of the apparatus by directly performing or instructing the apparatus to perform any of the position determination methods disclosed above.

### Some Examples

Example 1: A method performed by an apparatus, the method comprising: receiving, by the apparatus in a power saving state, a notification during a notification opportunity at a time-frequency resource, wherein the notification is apparatus-specific; decoding, by the apparatus, information carried by the notification, wherein the information includes downlink beam information.

Example 2: The method of Example 1, wherein the downlink beam information comprises a downlink beam direction or subspace.

Example 3: The method of Example 1 or Example 2, wherein the power saving state is a state in which the apparatus does not monitor downlink control information (DCI) until it enters a wake-up duration.

Example 4: The method of any one of Examples 1 to 3, wherein the notification is received in a downlink beam pointed in a direction of the apparatus.

Example 5: The method of Example 4, wherein the direction of the apparatus is based on a position of the apparatus.

Example 6: The method of any one of Examples 1 to 5, wherein the notification includes information specific to the apparatus.

Example 7: The method of Example 6, wherein the information specific to the apparatus includes at least one of the following: a paging message indicating that there is downlink data to transmit to the apparatus; short traffic; control information for the apparatus to trigger an action.

Examples 8: The method of any one of Examples 1 to 7, wherein a downlink beam in which the notification is received is not part of a downlink beam sweeping pattern, and wherein prior to receiving the notification the method further comprises synchronizing with a network using at least one synchronization signal in a beam of the downlink beam sweeping pattern.

Example 9: The method of Example 8, further comprising obtaining system information from the beam of the beam sweeping pattern, wherein the system information includes at least one of the following: an indication of whether there is the notification for the apparatus; configuration information for the notification opportunity.

Example 10: The method of any one of Examples 1 to 8, wherein prior to receiving the notification the method comprises receiving control signaling, wherein the control signaling includes at least one of the following: an indication of whether there is the notification for the apparatus; an indication that the apparatus is to switch to a different operating mode; a common short message from a network.

Example 11: An apparatus comprising: a receiver to receive, in a power saving state, a notification during a notification opportunity at a time-frequency resource, wherein the notification is apparatus-specific; a processor to decode information carried by the notification, wherein the information includes downlink beam information.

Example 12: The apparatus of Example 11, wherein the downlink beam information comprises a downlink beam direction or subspace.

Example 13: The apparatus of Example 11 or Example 12, wherein the power saving state is a state in which the apparatus does not monitor downlink control information (DCI) until it enters a wake-up duration.

Example 14: The apparatus of any one of Examples 11 to 13, wherein the notification is to be received in a downlink beam pointed in a direction of the apparatus.

Example 15: The apparatus of Example 14, wherein the direction of the apparatus is based on a position of the apparatus.

Example 16: The apparatus of any one of Examples 11 to 15, wherein the notification includes information specific to the apparatus.

Example 17: The apparatus of Example 16, wherein the information specific to the apparatus includes at least one of the following: a paging message indicating that there is downlink data to transmit to the apparatus; short traffic; control information for the apparatus to trigger an action.

Example 18: The apparatus of any one of Examples 11 to 17, wherein a downlink beam in which the notification is to be received is not part of a downlink beam sweeping pattern, and wherein prior to receiving the notification the apparatus is to synchronize with a network using at least one synchronization signal in a beam of the downlink beam sweeping pattern.

Example 19: The apparatus of Example 18, wherein the processor is to obtain system information from the beam of the beam sweeping pattern, wherein the system information includes at least one of the following: an indication of whether there is the notification for the apparatus; configuration information for the notification opportunity.

Example 20: The apparatus of any one of Examples 11 to 18, wherein prior to receiving the notification the receiver is to receive control signaling, wherein the control signaling includes at least one of the following: an indication of whether there is the notification for the apparatus; an indication that the apparatus is to switch to a different operating mode; a common short message from a network.

Example 21: A method performed by a network device, the method comprising: obtaining a position of an apparatus; during a notification opportunity, transmitting a notification for the apparatus at a time-frequency resource in a downlink beam pointed in a direction that is based on the position of the apparatus; wherein the notification is apparatus-specific and includes downlink beam information.

Example 22: The method of Example 21, wherein the downlink beam information comprises a downlink beam direction or subspace.

Example 23: The method of Example 21 or Example 22, wherein the notification includes information specific to the apparatus.

Example 24: The method of Example 23, wherein the information specific to the apparatus includes at least one of the following: a paging message indicating that there is downlink data to transmit to the apparatus; short traffic; control information for the apparatus to trigger an action.

Example 25: The method of any one of Examples 21 to 24, wherein the downlink beam is not part of a downlink beam sweeping pattern, and wherein prior to transmitting the downlink beam the method further comprises transmitting a plurality of beams of the downlink beam sweeping pattern, each beam of the plurality of beams carrying synchronization information for the apparatus to synchronize with the network.

Example 26: The method of Example 25, wherein each beam of the plurality of beams carries system information, and wherein the system information includes at least one of the following: an indication of whether there is the notification for the apparatus; configuration information for the notification opportunity.

Example 27: The method of any one of Examples 21 to 25, wherein prior to transmitting the notification the method comprises transmitting control signaling, wherein the control signaling includes at least one of the following: an indication of whether there is the notification for the apparatus; an indication that the apparatus is to switch to a different operating mode; a common short message from a network.

Example 28: The method of any one of Examples 21 to 27, wherein the apparatus is one of a plurality of apparatuses, and wherein the method comprises: obtaining a respective position of each apparatus of the plurality of apparatuses; for each apparatus of the plurality of apparatuses: transmitting a respective notification for that apparatus in a respective downlink beam pointed in the direction of that apparatus, wherein the direction of the respective downlink beam is based on the respective position of the apparatus.

Example 29: The method of Example 28, wherein the respective downlink beam for each apparatus of the plurality of apparatuses is in a different direction.

Example 30: A network device comprising: a processor to obtain a position of an apparatus; a transmitter to: during a notification opportunity, transmit a notification for the apparatus at a time-frequency resource in a downlink beam pointed in a direction that is based on the position of the apparatus, wherein the notification is apparatus-specific and includes downlink beam information.

Example 31: The network device of Example 30, wherein the downlink beam information comprises a downlink beam direction or subspace.

Example 32: The network device of Example 30 or Example 31, wherein the notification includes information specific to the apparatus.

Example 33: The network device of Example 32, wherein the information specific to the apparatus includes at least one of the following: a paging message indicating that there is downlink data to transmit to the apparatus; short traffic; control information for the apparatus to trigger an action.

Example 34: The network device of any one of Examples 30 to 33, wherein the downlink beam is not part of a downlink beam sweeping pattern, and wherein prior to transmitting the downlink beam the transmitter is to transmit a plurality of beams of the downlink beam sweeping pattern, each beam of the plurality of beams carrying synchronization information for the apparatus to synchronize with the network.

Example 35: The network device of Example 34, wherein each beam of the plurality of beams carries system information, and wherein the system information includes at least one of the following: an indication of whether there is the notification for the apparatus; configuration information for the notification opportunity.

Example 36: The network device of any one of Examples 30 to 34, wherein prior to transmitting the notification the transmitter is to transmit control signaling, wherein the control signaling includes at least one of the following: an indication of whether there is the notification for the apparatus; an indication that the apparatus is to switch to a different operating mode; a common short message from a network.

Example 37: The network device of any one of Examples 30 to 36, wherein the apparatus is one of a plurality of apparatuses, and wherein the network device is to: obtain a respective position of each apparatus of the plurality of apparatuses; for each apparatus of the plurality of apparatuses: transmit a respective notification for that apparatus in a respective downlink beam pointed in the direction of that apparatus, wherein the direction of the respective downlink beam is based on the respective position of the apparatus.

Example 38: The network device of Example 37, wherein the respective downlink beam for each apparatus of the plurality of apparatuses is in a different direction.

Although the present invention has been described with reference to specific features and embodiments thereof, various modifications and combinations can be made thereto without departing from the invention. The description and drawings are, accordingly, to be regarded simply as an illustration of some embodiments of the invention as defined by the appended claims, and are contemplated to cover any and all modifications, variations, combinations or equivalents that fall within the scope of the present invention. Therefore, although the present invention and its advantages have been described in detail, various changes, substitutions and alterations can be made herein without departing from the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

Moreover, any module, component, or device exemplified herein that executes instructions may include or otherwise have access to a non-transitory computer/processor readable storage medium or media for storage of information, such as computer/processor readable instructions, data structures, program modules, and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile disc (DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Any application or module herein described may be implemented using computer/processor readable/executable instructions that may be stored or otherwise held by such non-transitory computer/processor readable storage media.

1. A method performed by an apparatus, the method comprising:
receiving, by the apparatus in a power saving state, a notification during a notification opportunity at a time-frequency resource, wherein the notification is apparatus-specific;
decoding, by the apparatus, information carried by the notification, wherein the information includes downlink beam information.

2. The method of claim 1, wherein the downlink beam information comprises a downlink beam direction or subspace.

3. The method of claim 1, wherein the power saving state is a state in which the apparatus does not monitor downlink control information (DCI) until it enters a wake-up duration.

4. The method of claim 1, wherein the notification is received in a downlink beam pointed in a direction of the apparatus.

5. The method of claim 4, wherein the direction of the apparatus is based on a position of the apparatus.

6. The method of claim 1, wherein the notification includes information specific to the apparatus.

7. The method of claim 6, wherein the information specific to the apparatus includes at least one of the following: a paging message indicating that there is downlink data to transmit to the apparatus; short traffic; control information for the apparatus to trigger an action.

8. The method of claim 1, wherein a downlink beam in which the notification is received is not part of a downlink beam sweeping pattern, and wherein prior to receiving the notification the method further comprises synchronizing with a network using at least one synchronization signal in a beam of the downlink beam sweeping pattern.

9. The method of claim 8, further comprising obtaining system information from the beam of the beam sweeping pattern, wherein the system information includes at least one of the following: an indication of whether there is the notification for the apparatus; configuration information for the notification opportunity.

10. The method of claim 1, wherein prior to receiving the notification the method comprises receiving control signaling, wherein the control signaling includes at least one of the following:
an indication of whether there is the notification for the apparatus; an indication that the apparatus is to switch to a different operating mode; a common short message from a network.

11. An apparatus comprising:
a receiver to receive, in a power saving state, a notification during a notification opportunity at a time-frequency resource, wherein the notification is apparatus-specific;
a processor to decode information carried by the notification, wherein the information includes downlink beam information.

12. The apparatus of claim 11, wherein the downlink beam information comprises a downlink beam direction or subspace.

13. The apparatus of claim 11, wherein the power saving state is a state in which the apparatus does not monitor downlink control information (DCI) until it enters a wake-up duration.

14. The apparatus of claim 11, wherein the notification is to be received in a downlink beam pointed in a direction of the apparatus.

15. The apparatus of claim 14, wherein the direction of the apparatus is based on a position of the apparatus.

16. The apparatus of claim 11, wherein the notification includes information specific to the apparatus.

17. The apparatus of claim 16, wherein the information specific to the apparatus includes at least one of the following: a paging message indicating that there is downlink data to transmit to the apparatus; short traffic; control information for the apparatus to trigger an action.

18. The apparatus of claim 11, wherein a downlink beam in which the notification is to be received is not part of a downlink beam sweeping pattern, and wherein prior to receiving the notification the apparatus is to synchronize with a network using at least one synchronization signal in a beam of the downlink beam sweeping pattern.

19. The apparatus of claim 18, wherein the processor is to obtain system information from the beam of the beam sweeping pattern, wherein the system information includes at least one of the following: an indication of whether there is the notification for the apparatus; configuration information for the notification opportunity.

20. The apparatus of claim 11, wherein prior to receiving the notification the receiver is to receive control signaling, wherein the control signaling includes at least one of the following: an indication of whether there is the notification for the apparatus; an indication that the apparatus is to switch to a different operating mode; a common short message from a network.
